(19) United States
(12) Patent Application Publication
(10) Pub. No.: US 2025/0297651 A1
(43) Pub. Date: Sep. 25, 2025

(54) CLUTCH DEVICE

(71) Applicant: Kabushiki Kaisha F.C.C., Hamamatsu-shi (JP)

(72) Inventors: Yuki KOBAYASHI, Hamamatsu-shi (JP); Han Hiong CHEN, Hamamatsu-shi (JP)

(21) Appl. No.: 19/233,261

(22) Filed: Jun. 10, 2025

Related U.S. Application Data
(63) Continuation of application No. PCT/JP2024/026632, filed on Jul. 25, 2024.

(30) Foreign Application Priority Data
Aug. 23, 2023 (JP) 2023-135859
May 21, 2024 (JP) 2024-082648

(51) Int. Cl. F16D 43/08; F16D 13/70; F16D 21/08

(52) U.S. Cl. CPC F16D 43/08; F16D 13/70; F16D 21/08

(57) ABSTRACT

A centrifugal clutch mechanism of a clutch device includes a holder to hold weights movable between radially inward positions and radially outward positions, springs to urge the weights in a radially inward direction, a pressure-contact structure movable in an axial direction of an output shaft by movement of the weights from the radially inward positions to the radially output positions to put input-side rotating plates and output-side rotating plates into pressure contact with each other, and urging structures between the holder and the pressure-contact structure in the axial direction of the output shaft, the urging structures urging the weights held by the holder in the axial direction of the output shaft and permitting the weights to move in a radial direction.

### CROSS REFERENCE TO RELATED APPLICATIONS

This application claims the benefit of priority to Japanese Patent Application No. 2023-135859 filed on Aug. 23, 2023, Japanese Patent Application No. 2024-082648 filed on May 21, 2024, and is a Continuation Application of PCT Application No. PCT/JP2024/026632 filed on Jul. 25, 2024. The entire contents of each application are hereby incorporated herein by reference.

### BACKGROUND OF THE INVENTION

### 1. Field of the Invention

The present invention relates to clutch devices.

### 2. Description of the Related Art

A straddled vehicle such as a motorcycle or the like includes a clutch device capable of allowing or blocking transfer of a rotation driving force of a motive power source such as an engine or the like to a drive wheel. For example, Japanese Patent Application Publication No. 2022-30211 discloses a clutch device including an input (hereinafter, referred to as an “input shaft”) coupled to the side of the engine, an output (hereinafter, referred to as an “output shaft”) coupled to the side of the drive wheel, a clutch (hereinafter, referred to as a “clutch center”) coupled with the output shaft, and a pressure structure movable toward, or away from, the clutch center.

The clutch device described in Japanese Patent Application Publication No. 2022-30211 also includes a centrifugal clutch mechanism including weights movable in a radial direction. The weights move from radially inward positions to radially outward positions by a centrifugal force caused by a rotation of a clutch housing to put drive-side clutch plates (hereinafter, referred to as “input-side rotating plates”) and driven-side clutch plates (hereinafter, referred to as “output-side rotating plates”) into pressure contact with each other, and thus transfer the driving force of the engine to a wheel.

### SUMMARY OF THE INVENTION

The centrifugal clutch mechanism includes a holder and a pressure-contact structure positioned in an axial direction of the output shaft. The holder holds the weights such that the weights are movable in the radial direction. The pressure-contact structure puts the input-side rotating plates and the output-side rotating plates into pressure contact with each other along with the movement of the weights in the radial direction. The weights are urged inward in the radial direction by springs provided in the holder. In the axial direction of the output shaft, there is a space between the weights and the holder and also between the weights and the pressure-contact structure. Therefore, the weights may vibrate in the axial direction of the output shaft by a vibration of the engine or the like. When the clutch housing is rotated in a state where the weights are vibrating in the axial direction of the output shaft, it is possible that a thrust in the axial direction of the output shaft generated in the weights by a centrifugal force caused by the rotation of the clutch housing is not effectively transferred to the pressure-contact structure.

Example embodiments s of the present invention provide clutch devices capable of effectively transferring a thrust in an axial direction of an output shaft, generated in weights by a centrifugal force, to a pressure-contact structure.

A clutch device according to an example embodiment of the present invention is a clutch device to allow or block transfer of a rotation driving force of an input shaft to an output shaft. The clutch device includes a clutch center housed in a clutch housing holding a plurality of input-side rotating plates rotationally drivable by rotational driving of the input shaft, the clutch center being rotationally drivable together with the output shaft, a pressure structure movable toward, or away from, the clutch center, the pressure structure being configured to press the input-side rotating plates and the output-side rotating plates which are alternately arranged with the input-side rotating plates, and a centrifugal clutch mechanism including a plurality of weights movable from radially inward positions to radially outward positions by a centrifugal force caused by the rotation of the clutch housing. When the weights are at the radially outward positions, the centrifugal clutch mechanism places the input-side rotating plates and the output-side rotating plates into pressure contact with each other to provide a state where the transfer of the rotation driving force of the input shaft to the output shaft is allowed. When the weights are at the radially inward positions, the centrifugal clutch mechanism releases the input-side rotating plates and the output-side rotating plates from a contact pressure force to provide a state where the transfer of the rotation driving force of the input shaft to the output shaft is blocked. The centrifugal clutch mechanism includes a holder to hold the weights such that the weights are movable between the radially inward positions and the radially outward positions, an elastic structure urging the weights in a radially inward direction, a pressure-contact structure movable in an axial direction of the output shaft, by the movement of the weights from the radially inward positions to the radially output positions, to put the input-side rotating plates and the output-side rotating plates into pressure contact with each other, and urging structures located between the holder and the pressure-contact structure in the axial direction of the output shaft, the urging structures urging the weights held by the holder in the axial direction of the output shaft and permitting the weights to move in a radial direction.

According to the clutch devices of example embodiments of the present invention, the urging structures of the centrifugal clutch mechanism are located between the holder and the pressure-contact structure in the axial direction of the output shaft, and urge the weights held by the holder in the axial direction of the output shaft and permit the weights to move in the radial direction. According to the above-described example embodiments, the weights are urged in the axial direction of the output shaft by the urging structures. Therefore, even though the engine or the like vibrates, the vibration of the weights in the axial direction of the output shaft is reduced or minimized. As a result, the weights move smoothly in the radial direction. Therefore, the thrust in the axial direction of the output shaft, generated in the weights by the centrifugal force caused by the rotation of the clutch housing, is effectively transferred to the pressure-contact structure.

Example embodiments of the present invention provide clutch devices capable of effectively transferring the thrust in the axial direction of the output shaft, generated in the weights by the centrifugal force, to the pressure-contact structure.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a cross-sectional view of a clutch device according to example embodiment 1 of the present invention.

FIG. 2 is a perspective view of a first clutch center according to example embodiment 1 of the present invention.

FIG. 3 is a perspective view of the first clutch center according to example embodiment 1 of the present invention.

FIG. 4 is a perspective view of a second clutch center according to example embodiment 1 of the present invention.

FIG. 5 is a plan view of the second clutch center according to example embodiment 1 of the present invention.

FIG. 6 is a perspective view of a pressure structure according to example embodiment 1 of the present invention.

FIG. 7 is a perspective view of a first pressure structure according to example embodiment 1 of the present invention.

FIG. 8 is a perspective view of the first pressure structure according to example embodiment 1 of the present invention.

FIG. 9 is a perspective view of a second pressure structure according to example embodiment 1 of the present invention.

FIG. 10 is a perspective view of the second pressure structure according to example embodiment 1 of the present invention.

FIG. 11A is a schematic view illustrating effects of a center-side assist cam surface and a pressure-side assist cam surface.

FIG. 11B is a schematic view illustrating effects of a center-side slipper cam surface and a pressure-side slipper cam surface.

FIG. 12 is a perspective view of a centrifugal clutch mechanism according to example embodiment 1 of the present invention.

FIG. 13 is a cross-sectional view of the centrifugal clutch mechanism according to example embodiment 1 of the present invention.

FIG. 14 is a perspective view showing the centrifugal clutch mechanism according to example embodiment 1 in a state where a pressure-contact structure is detached therefrom.

FIG. 15 is a perspective view showing the centrifugal clutch mechanism according to example embodiment 1 in a state where the pressure-contact structure and a guide are detached therefrom.

FIG. 16 is a plan view showing the centrifugal clutch mechanism according to example embodiment 1 in a state where the pressure-contact structure and the guide are detached therefrom.

FIG. 17 is a perspective view of an urging structure of the centrifugal clutch mechanism according to example embodiment 1.

FIG. 18 is a plan view of a portion of a centrifugal clutch mechanism according to example embodiment 2, showing a state where weights are located at radially inward positions.

FIG. 19 is a perspective view of a weight according to example embodiment 2 of the present invention.

FIG. 20 is a plan view of the weight according to example embodiment 2 of the present invention.

FIG. 21 is a perspective view of the weight according to example embodiment 2 of the present invention.

FIG. 22 is a bottom view of the weight according to example embodiment 2 of the present invention.

FIG. 23 is a side view of the weight according to example embodiment 2 of the present invention.

FIG. 24 is a plan view of a portion of a centrifugal clutch mechanism according to example embodiment 3, showing a state where weights are located at radially inward positions.

FIG. 25 is a perspective view of a weight according to example embodiment 3 of the present invention.

FIG. 26 is a bottom view of the weight according to example embodiment 3 of the present invention.

FIG. 27 is a side view of the weight according to example embodiment 3 of the present invention.

FIG. 28A is a perspective view of a configuration of an urging structure and the vicinity thereof according to example embodiment 4 of the present invention.

FIG. 28B is a cross-sectional view of the configuration of the urging structure and the vicinity thereof according to example embodiment 4 of the present invention.

FIG. 29A is a perspective view of a configuration of an urging structure and the vicinity thereof according to example embodiment 5 of the present invention.

FIG. 29B is a cross-sectional view of the configuration of the urging structure and the vicinity thereof according to example embodiment 5 of the present invention.

### DETAILED DESCRIPTION OF THE EXAMPLE EMBODIMENTS

Hereinafter, example embodiments of clutch devices according to the present invention will be described with reference to the drawings. The example embodiments described herein are, of course, not intended to particularly limit the present invention. Elements and portions having the same functions are denoted by the same reference signs, and description for the same elements and portions will be omitted or simplified as appropriate.

### Example Embodiment 1

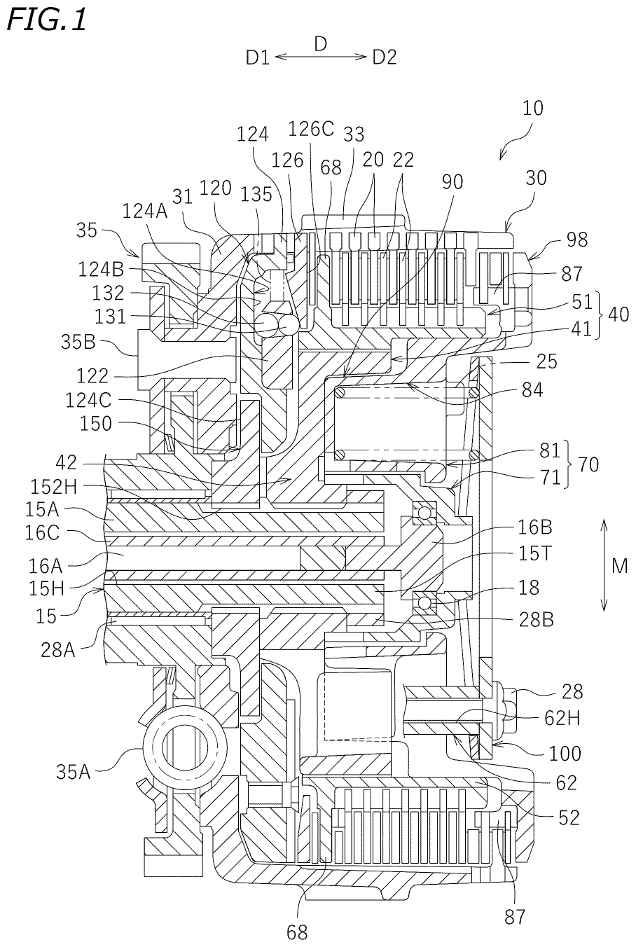

FIG. 1 is a cross-sectional view of a clutch device 10 according to this example embodiment. The clutch device 10 is preferably provided in, for example, a straddled vehicle such as a motorcycle or the like. The clutch device 10, for example, allows or blocks transfer of a rotation driving force of an input shaft (crankshaft) of an engine, which is a motive power source of the motorcycle, to an output shaft 15. The clutch device 10 allows or blocks transfer of the rotation driving force of the input shaft to a drive wheel (rear wheel) through the output shaft 15. The clutch device 10 is located between the engine and a transmission.

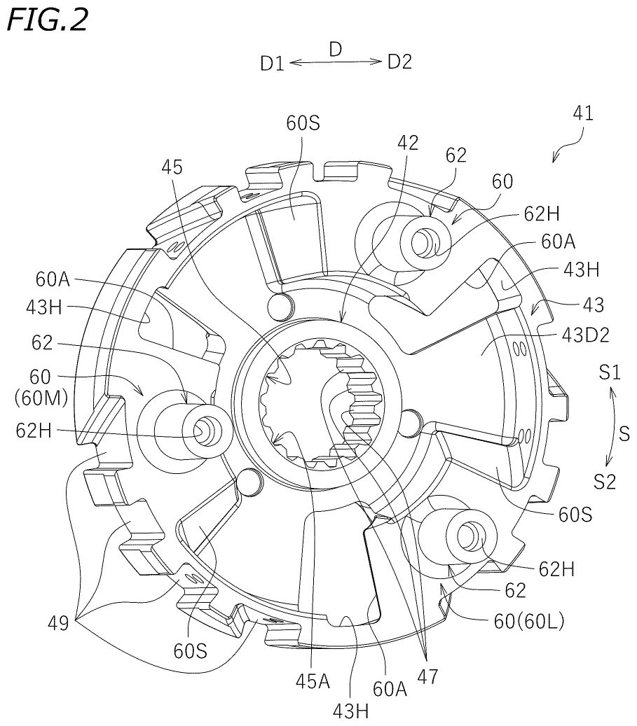

In the following description, a direction in which a pressure structure 70 of the clutch device 10 moves toward, and away from, a clutch center 40 will be referred to as a direction D. A direction in which the pressure structure 70 moves toward the clutch center 40 will be referred to as a first direction D1, and a direction in which the pressure structure 70 moves away from the clutch center 40 will be referred to as a second direction D2. A circumferential direction (i.e., a rotation direction) of the clutch center 40 and the pressure structure 70 will be referred to as a circumferential direction S. Regarding the circumferential direction S, a direction from one center-side cam portion 60 toward another center-side cam portion 60 (a direction from one pressure-side cam portion 90 toward another pressure-side cam portion 90) will be referred to as a first circumferential direction S1 (see FIG. 2), and a direction from the other center-side cam portion 60 toward the one center-side cam portion 60 (a direction from the other pressure-side cam portion 90 toward the one pressure-side cam portion 90) will be referred to as a second circumferential direction S2 (see FIG. 2). A radial direction of the output shaft 15 will be referred to as a radial direction M. A direction away from the output shaft 15 will be referred to as an outward direction M1 (see FIG. 20), and a direction toward the output shaft 15 will be referred to as an inward direction M2 (see FIG. 20). In this example embodiment, the axial direction of the output shaft 15 is the same as the direction D. The pressure structure 70 and the clutch center 40 rotate in the first circumferential direction S1 (i.e., a direction from a center-side assist cam surface 60A toward a center-side slipper cam surface 60S of one center-side cam portion 60). It should be noted that the directions described above are defined simply for the convenience of description, and are not intended to limit the state of installation of the clutch device 10 in any way, or to limit the present invention in any way.

As shown in FIG. 1, the clutch device 10 preferably includes the output shaft 15, a plurality of input-side rotating plates 20, a plurality of output-side rotating plates 22, a clutch housing 30, the clutch center 40, the pressure structure 70, stopper plates 100, a centrifugal clutch mechanism 120, and an assisting clutch plate 150.

As shown in FIG. 1, the output shaft 15 is preferably a hollow shaft. One end of the output shaft 15 supports an input gear 35 described below and the clutch housing 30 via a needle bearing 28A such that the input gear 35 and the clutch housing 30 are rotatable. The output shaft 15 supports the clutch center 40 via a nut 28B such that the clutch center 40 is secured. That is, the output shaft 15 rotates integrally with the clutch center 40. Another end of the output shaft 15 is coupled with, for example, a transmission (not shown) of a motorcycle.

As shown in FIG. 1, the output shaft 15 includes a body 15A extending in the direction D. The body 15A includes an oil flow path 15H through which clutch oil flows. The oil flow path 15H is provided between a sleeve 16C outserted over a push rod 16A described below and the body 15A. The clutch oil flows in the output shaft 15, that is, in the oil flow path 15H of the body 15A.

As shown in FIG. 1, the push rod 16A and a pusher 16B adjacent to the push rod 16A are provided in the oil flow path 15H of the output shaft 15. The push rod 16A and the pusher 16B are slidable in the sleeve 16C. The push rod 16A has one end thereof (left end in the figure) coupled with a clutch operation lever (not shown) of the motorcycle, and slides in the sleeve 16C by an operation made on the clutch operation lever to press the pusher 16B in the second direction D2. A portion of the pusher 16B protrudes outward of the output shaft 15 (in this example embodiment, in the second direction D2), and is coupled with a release bearing 18 provided on the pressure structure 70. The sleeve 16C and the pusher 16B each have a diameter shorter than an inner diameter of the body 15A, so that the clutch oil is guaranteed to flow easily in the oil flow path 15H.

The clutch housing 30 is preferably molded by being die-cast with aluminum, for example. The clutch housing 30 has a bottomed cylindrical shape. As shown in FIG. 1, the clutch housing 30 includes a bottom wall 31 having a generally circular shape and a side wall 33 extending in the second direction D2 from an edge of the bottom wall 31. The clutch housing 30 holds the plurality of input-side rotating plates 20.

As shown in FIG. 1, the input gear 35 is provided on the bottom wall 31 of the clutch housing 30. The input gear 35 is preferably secured to the bottom wall 31 by a rivet 35B via a torque damper 35A. The input gear 35 is meshed with a drive gear (not shown) rotatable by rotational driving of the input shaft of the engine. The input gear 35 is rotationally drivable integrally with the clutch housing 30, independently from the output shaft 15.

The input-side rotating plates 20 are rotationally drivable by the rotational driving of the input shaft. As shown in FIG. 1, the input-side rotating plates 20 are held on an inner circumferential surface of the side wall 33 of the clutch housing 30. The input-side rotating plates 20 are held by the clutch housing 30 through spline fitting. The input-side rotating plates 20 are displaceable in the axial direction of the clutch housing (i.e., in the direction D). The input-side rotating plates 20 are integrally rotatable with the clutch housing 30.

The input-side rotating plates 20 are pushed against the output-side rotating plates 22. The input-side rotating plates 20 are preferably annular. The input-side rotating plates 20 are preferably molded by being die-cast with aluminum. The input-side rotating plates 20 preferably include a plurality of friction surfaces (not shown) made of paper pasted on a front surface and a rear surface thereof. Grooves each having a depth of several hundred micrometers are provided between the friction surfaces to hold the clutch oil.

As shown in FIG. 1, the clutch center 40 is housed in the clutch housing 30. The clutch center 40 is located concentrically with the clutch housing 30. The clutch center 40 holds the plurality of output-side rotating plates 22. The output-side rotating plates 22 are located alternately with the input-side rotating plates 20. The clutch center 40 is rotationally drivable integrally with the output shaft 15. The clutch center 40 includes a first clutch center 41 and a second clutch center 51. The first clutch center 41 and the second clutch center 51 are mutually assembled together. The second clutch center 51 is located ahead of the first clutch center 41 in the outward direction M1 of the radial direction M. The second clutch center 51 is preferably outserted over the first clutch center 41.

As shown in FIG. 2, the first clutch center 41 includes an output shaft holding portion 42, an annular base wall 43 located ahead of the output shaft holding portion 42 in the outward direction M1 of the radial direction M, and the plurality of center-side cam portions 60.

As shown in FIG. 1, the output shaft holding portion 42 is coupled with the output shaft 15. A first pressure structure 71 described below is preferably outserted over the output shaft holding portion 42. As shown in FIG. 2, the output shaft holding portion 42 is cylindrical. The output shaft holding portion 42 preferably includes an insertion hole 45 into which the output shaft 15 is inserted and with which the output shaft 15 is spline-fitted. The insertion hole 45 preferably penetrates the output shaft holding portion 42. An inner wall 45A, of the output shaft holding portion 42, that defines the insertion hole 45 preferably includes a plurality of fitting teeth 47 which extend in the axial direction of the output shaft 15 (i.e., in the direction D). The fitting teeth 47 are fitted with the output shaft 15.

Each of the center-side cam portions 60 preferably has a truncated quadrangular pyramid shape including a cam surface including a slope acting as an Assist & Slipper (registered trademark) mechanism. The cam surface as the Assist & Slipper (registered trademark) mechanism generates an assist torque as a force increasing a pressing force (contact pressure force) between the input-side rotating plates 20 and the output-side rotating plates 22 or a slipper torque as a force decreasing the pressing force (contact pressure force) between the input-side rotating plates 20 and the output-side rotating plates 22 and shifting these plates into a half-clutch state. As shown in FIG. 2, each center-side cam portion 60 projects in the second direction D2 from a surface 43D2, on the side of the second direction D2, of the base wall 43. The center-side cam portions 60 are preferably located at an equal interval in the circumferential direction S of the first clutch center 41. In this example embodiment, the first clutch center 41 preferably includes three center-side cam portions 60. However, the number of the center-side cam portions 60 is not limited to three, and can be any desirable number.

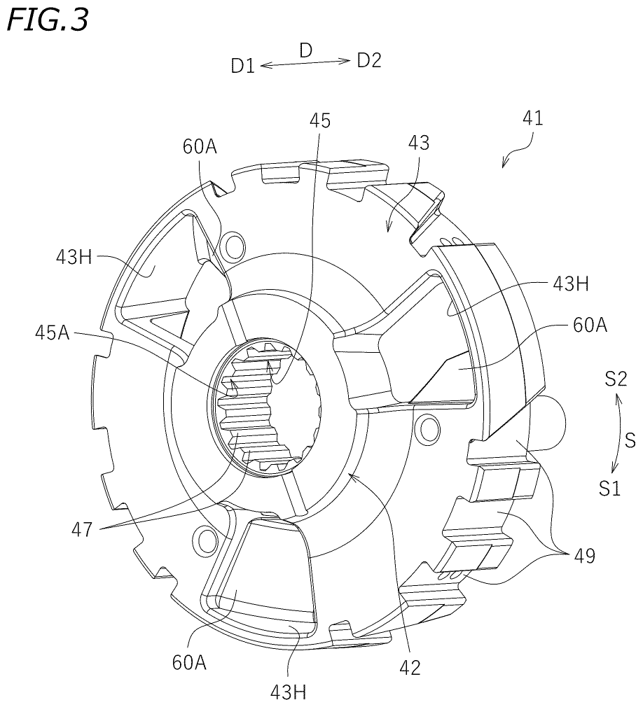

As shown in FIG. 2, the center-side cam portions 60 are located ahead of the output shaft holding portion 42 in the outward direction M1 of the radial direction M. The center-side cam portions 60 each include the center-side assist cam surface 60A (see also FIG. 3) and the center-side slipper cam surface 60S. The center-side assist cam surface 60A is configured to generate a force in such a direction as to move the pressure structure 70 toward the clutch center 40, in order to increase the pressing force (contact pressure force) between the input-side rotating plates 20 and the output-side rotating plates 22, when the clutch center 40 rotates with respect to the pressure structure 70. In this example embodiment, when this force is generated, the position of the pressure structure 70 with respect to the clutch center 40 does not change, and the pressure structure 70 does not need to move toward the clutch center 40 physically. The pressure structure 70 may be displaced with respect to the clutch center 40 physically. The center-side slipper cam surface 60S is configured to separate the pressure structure 70 from the clutch center 40, to decrease the pressing force (contact pressure force) between the input-side rotating plates 20 and the output-side rotating plates 22, when the clutch center 40 rotates with respect to the pressure structure 70. Regarding two of the center-side cam portions 60 adjacent to each other in the circumferential direction S, the center-side assist cam surface 60A of one center-side cam portion 60L and the center-side slipper cam surface 60S of the other center-side cam portion 60M are opposed to each other in the circumferential direction S.

As shown in FIG. 2, the first clutch center 41 includes a plurality of (in this example embodiment, three) bosses 62. The bosses 62 hold the pressure structure 70 indirectly. The plurality of bosses 62 are located at an equal interval in the circumferential direction S. The bosses 62 are each preferably cylindrical. The bosses 62 are located ahead of the output shaft holding portion 42 in the outward direction M1 of the radial direction M. The bosses 62 extend toward the pressure structure 70 (i.e., in the second direction D2). The bosses 62 are respectively provided on the center-side cam portions 60. The bosses 62 are each provided between the center-side assist cam surface 60A and the center-side slipper cam surface 60S in the direction S. The bosses 62 each have a screw hole 62H into which a bolt 28 (see FIG. 1) is inserted. The screw hole 62H extends in the axial direction of the clutch center 40 (i.e., in the direction D).

As shown in FIG. 2 and FIG. 3, the first clutch center 41 preferably includes center-side cam holes 43H penetrating a portion of the base wall 43. The center-side cam holes 43H penetrate the base wall 43 in the direction D. The center-side cam holes 43H are each located between adjacent ones of the center-side cam portions 60 in the circumferential direction S. As seen in the axial direction of the clutch center 40, each center-side assist cam surface 60A and the corresponding center-side cam hole 43H partially overlap each other.

As shown in FIG. 2, the first clutch center 41 preferably includes a plurality of engagement grooves 49. The engagement grooves 49 are provided in an outer circumferential surface of the base wall 43. The engagement grooves 49 are recessed in the inward direction M2 of the direction radial M from the outer circumferential surface of the base wall 43.

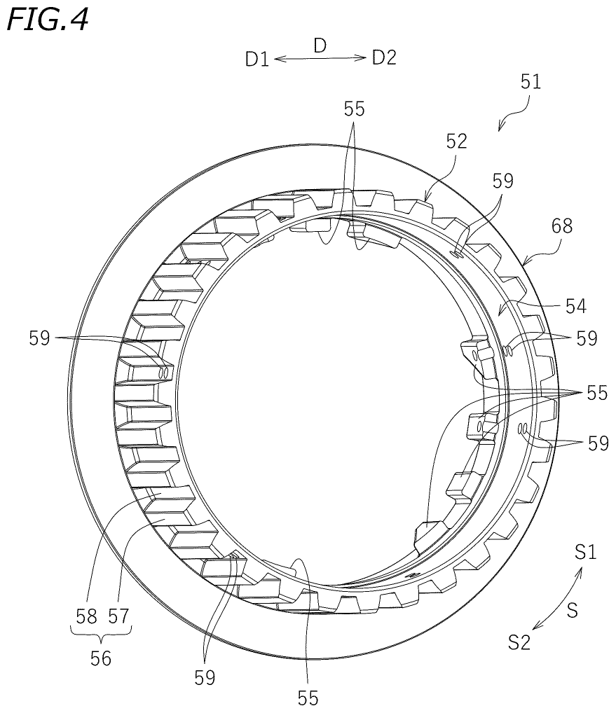

As shown in FIG. 4, the second clutch center 51 includes an annular outer circumferential wall 52, a flange 68 extending in the outward direction M1 of the radial direction M from the outer circumferential wall 52, and a center-side fitting portion 54. The second clutch center 51 holds the plurality of output-side rotating plates 22 located alternately with the input-side rotating plates 20.

As shown in FIG. 4, a spline fitting portion 56 is preferably provided on an outer circumferential surface of the outer circumferential wall 52. The spline fitting portion 56 includes a plurality of center-side fitting teeth 57 extending in the axial direction of the second clutch center 51 (i.e., in the direction D) and positioned along the outer circumferential surface of the outer circumferential wall 52, a plurality of spline grooves 58 each located between adjacent ones of the center-side fitting teeth 57 and extending in the axial direction of the second clutch center 51 (i.e., in the direction D), and oil discharge holes 59. The center-side fitting teeth 57 hold the output-side rotating plates 22. The plurality of center-side fitting teeth 57 are provided in the circumferential direction S. The plurality of center-side fitting teeth 57 are preferably spaced at an equal interval in the circumferential direction S. The plurality of center-side fitting teeth 57 preferably have the same shape as each other. The center-side fitting teeth 57 project in the outward direction M1 of the radial direction M from the outer circumferential surface of the outer circumferential wall 52. The oil discharge holes 59 penetrate the outer circumferential wall 52 in the radial direction M. The oil discharge holes 59 are located between adjacent ones of the center-side fitting teeth 57. That is, the oil discharge holes 59 are provided in the spline grooves 58. The oil discharge holes 59 are provided in the center-side fitting portion 54. The oil discharge holes 59 communicate the inside and the outside of the second clutch center 51 to each other. The oil discharge holes 59 discharge the clutch oil or the like, flowing into the clutch center 40 from the output shaft 15, to the outside of the clutch center 40. The clutch oil discharged from the oil discharge holes 59 is supplied to the input-side rotating plates 20 and the output-side rotating plates 22 located ahead of the oil discharge holes 59 in the outward direction M1 of the radial direction M.

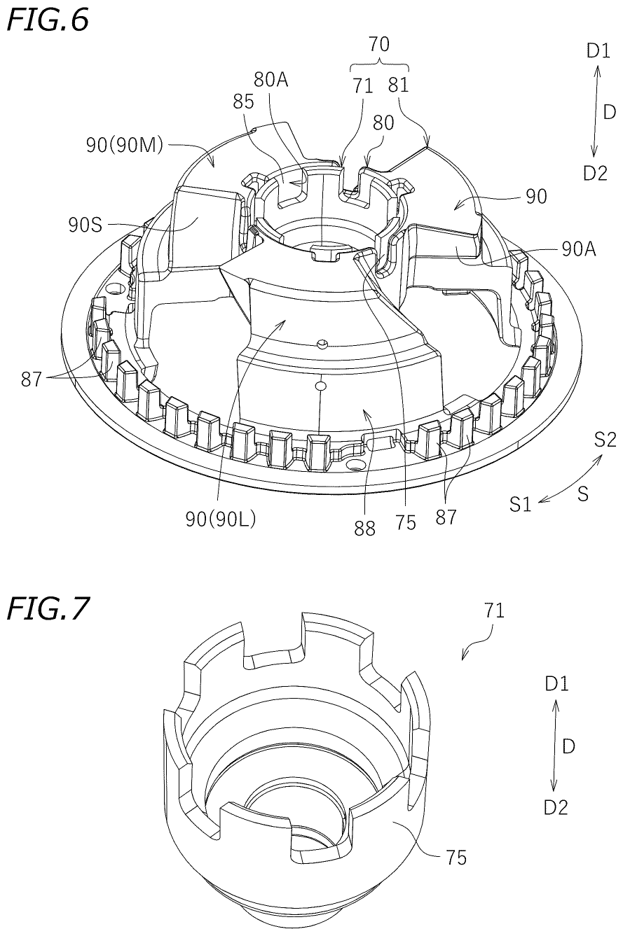

The output-side rotating plates 22 are held by the spline fitting portion 56 of the second clutch center 51 and the pressure structure 70. A portion of the output-side rotating plates 22 is held, through spline fitting, by the center-side fitting teeth 57 and the spline grooves 58 of the second clutch center 51. Another portion of the output-side rotating plates 22 is held by pressure-side fitting teeth 87 described below (see FIG. 6) of the pressure structure 70. The output-side rotating plates 22 are displaceable in the axial direction of the clutch center 40 (i.e., in the direction D). The output-side rotating plates 22 are integrally rotatable with the clutch center 40. All the output-side rotating plates 22 may be held by the pressure structure 70 (e.g., the pressure-side fitting teeth 87).

The output-side rotating plates 22 are pushed against the input-side rotating plates 20. The output-side rotating plates 22 are preferably annular. The output-side rotating plates 22 are each molded by punching a thin plate of an SPCC material into an annular shape. The friction surfaces included in the input-side rotating plates 20 may be provided in the output-side rotating plates 22 instead of the input-side rotating plates 20, or may be provided in both of the input-side rotating plates 20 and the output-side rotating plates 22.

As shown in FIG. 4, the center-side fitting portion 54 is provided on an inner circumferential surface of the outer circumferential wall 52. The center-side fitting portion 54 is preferably slidably outserted over pressure-side fitting portions 88 described below (see FIG. 6). An inner diameter of the center-side fitting portion 54 is set to have a fitting tolerance that permits the clutch oil, flowing out from a tip 15T (see FIG. 1) of the output shaft 15, to flow between the center-side fitting portion 54 and the pressure-side fitting portions 88. That is, there is a gap provided between the center-side fitting portion 54 and the pressure-side fitting portions 88.

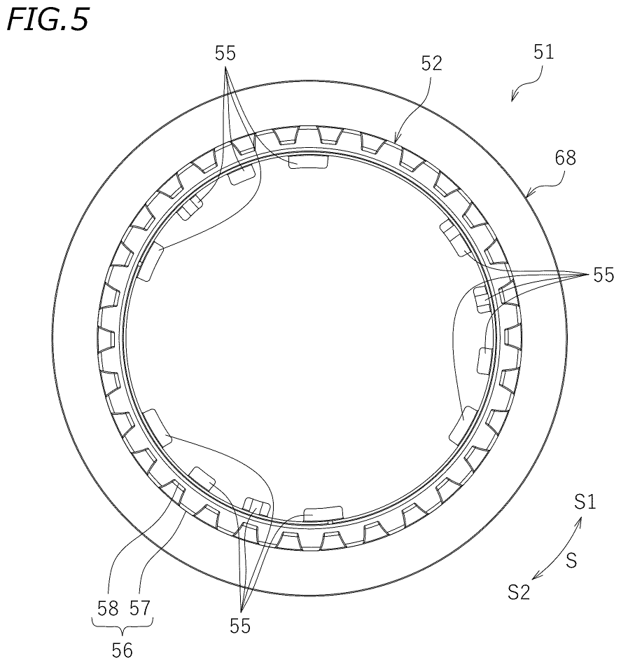

As shown in FIG. 4 and FIG. 5, the second clutch center 51 preferably includes a plurality of engagement projections 55. The engagement projections 55 are engaged with the engagement grooves 49 (see FIG. 2) of the first clutch center 41. The engagement projections 55 are provided on the inner circumferential surface of the outer circumferential wall 52. The engagement projections 55 project in the inward direction M2 of the radial direction M from the inner circumferential surface of the outer circumferential wall 52. The engagement projections 55 are located ahead of the outer circumferential wall 52 in the first direction D1.

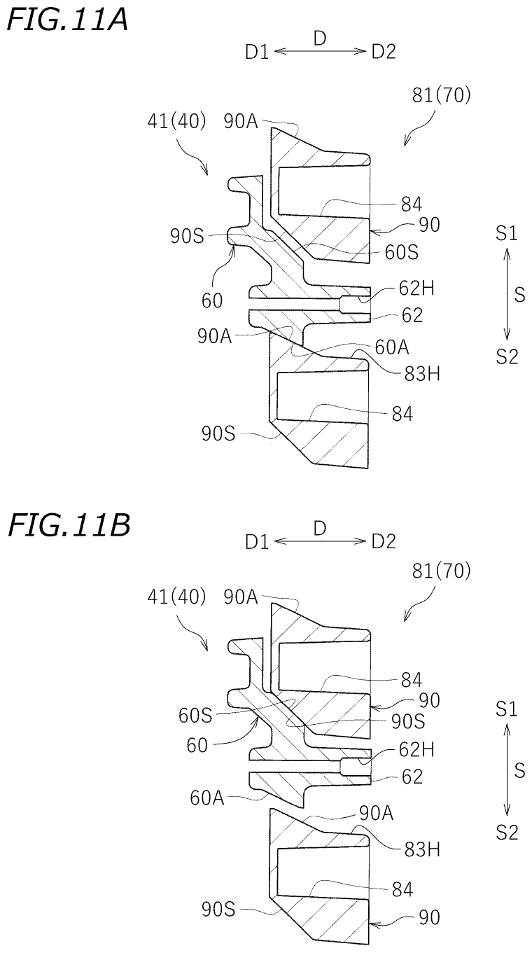

As shown in FIG. 1, the pressure structure 70 is movable toward, or away from, the clutch center 40. The pressure structure 70 is rotatable with respect to the clutch center 40. The pressure structure 70 is capable of pressing the input-side rotating plates 20 and the output-side rotating plates 22. The pressure structure 70 is located concentrically with the clutch center 40 and the clutch housing 30. As shown in FIG. 6, the pressure structure 70 preferably includes a first pressure structure 71 and a second pressure structure 81. The first pressure structure 71 and the second pressure structure 81 are mutually assembled together. The second pressure structure 81 is located ahead of the first pressure structure 71 in the outward direction M1 of the radial direction M. The second pressure structure 81 is preferably outserted over the first pressure structure 71. The first pressure structure 71 and the second pressure structure 81 are movable with respect to each other in the direction D. The first pressure structure 71 and the second pressure structure 81 are rotatable with respect to each other within a predetermined angle range in the circumferential direction S. The “predetermined angle range” refers to a range of angles by which the first pressure structure 71 and the second pressure structure 81 are rotated from a state in FIG. 11A (a state where a pressure-side assist cam surface 90A described below and the center-side assist cam surface 60A are in contact with each other) to a state in FIG. 11B (more specifically, a state where a pressure-side slipper cam surface 90S described below and the center-side slipper cam surface 60S are in contact with each other and the second pressure structure 81 contacts the stopper plates 100). As described above, the pressure structure 70 preferably includes the first pressure structure 71 and the second pressure structure 81, and therefore, allows the first pressure structure 71 and the second pressure structure 81 to move (rotate) independently from each other.

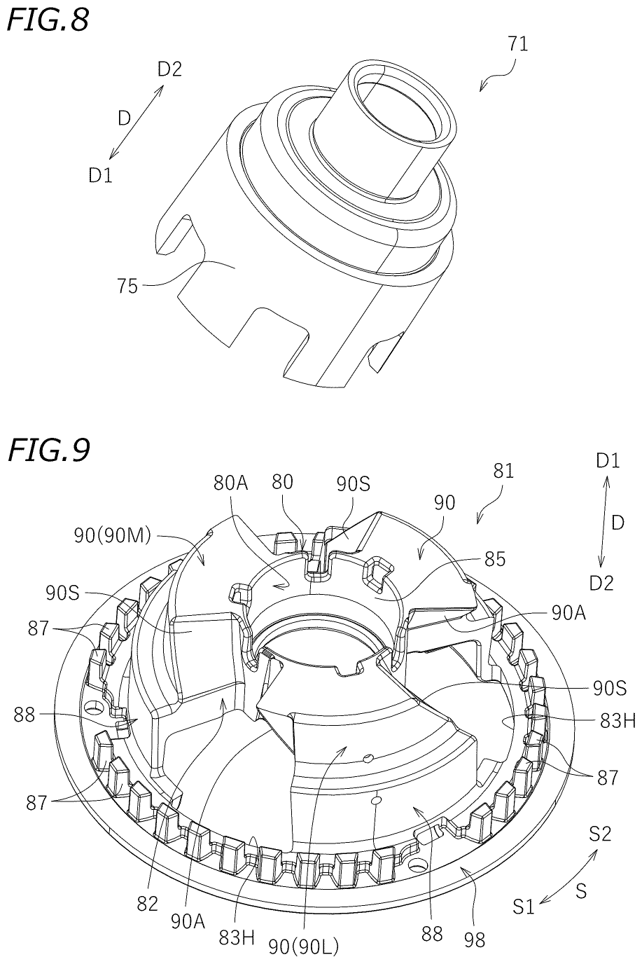

As shown in FIG. 7 and FIG. 8, the first pressure structure 71 is cylindrical. The first pressure structure 71 is preferably outserted over the output shaft holding portion 42 (see FIG. 1). The first pressure structure 71 houses the tip 15T (see FIG. 1) of the output shaft 15. The first pressure structure 71 receives a pressing force from the pusher 16B (see FIG. 1). The first pressure structure 71 is movable in the second direction D2 by a clutch operation (e.g., an operation made on a clutch lever or a button). The first pressure structure 71 receives the clutch oil flowing out from the tip 15T of the output shaft 15. The first pressure structure 71 is preferably outserted over the output shaft holding portion 42, so that the pressure structure 70 is positioned with respect to the clutch center 40. The release bearing 18 is located inward of the first pressure structure 71. The first pressure structure 71 holds the release bearing 18.

As shown in FIG. 1, the second pressure structure 81 is movable in the second direction D2 by being pressed by the first pressure structure 71. The second pressure structure 81 is inserted into the second clutch center 51. With this configuration, the second pressure structure 81 is positioned in the radial direction M. The second pressure structure 81 is slidable against the second clutch center 51 in the direction D. The second pressure structure 81 and the second clutch center 51 are rotatable with respect to each other in the circumferential direction S. As shown in FIG. 9, the second pressure structure 81 includes a body 82, and a flange 98 connected with an outer circumferential edge, on the side of the second direction D2, of the body 82 and extending in the outward direction M1 of the radial direction M. The body 82 projects ahead of the flange 98 in the first direction D1. The flange 98 is located ahead of a cylindrical portion 80 described below in the outward direction M1 of the radial direction M. The second pressure structure 81 holds the plurality of output-side rotating plates 22 located alternately with the input-side rotating plates 20. The flange 98 is capable of pressing the input-side rotating plates 20 and the output-side rotating plates 22.

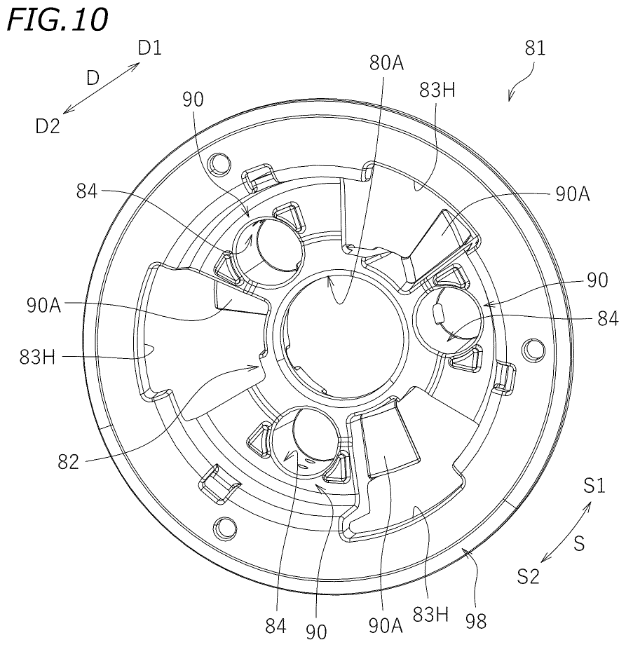

As shown in FIG. 9, the body 82 preferably includes the cylindrical portion 80, the plurality of pressure-side cam portions 90, the plurality of pressure-side fitting portions 88, and spring housings 84 (see FIG. 10).

As shown in FIG. 9, the cylindrical portion 80 includes a partition wall 80A that is cylindrical. The cylindrical portion 80 is preferably provided integrally with the pressure-side cam portions 90. The pressure-side cam portions 90 are located ahead of the partition wall 80A in the outward direction M1 of the radial direction M. As shown in FIG. 6, the cylindrical portion 80 houses the first pressure structure 71. An inner circumferential surface 85 of the partition wall 80A is slidable against an outer circumferential surface 75 of the first pressure structure 71 in the direction D.

Each of the pressure-side cam portions 90 preferably has a truncated quadrangular pyramid shape including a sloped cam surface acting as an Assist & Slipper (registered trademark) mechanism. The cam surface as the Assist & Slipper (registered trademark) mechanism generates an assist torque or a slipper torque as a result of sliding against the corresponding center-side cam portion 60 (see FIG. 2 and the like). As shown in FIG. 9, each pressure-side cam portion 90 projects ahead of the flange 98 in the first direction D1. The pressure-side cam portions 90 are located at an equal interval in the circumferential direction S of the second pressure structure 81. In this example embodiment, the second pressure structure 81 includes three pressure-side cam portions 90. However, the number of the pressure-side cam portions 90 is not limited to three and may be any desirable number.

As shown in FIG. 9, the pressure-side cam portions 90 are located ahead of the cylindrical portion 80 in the outward direction M1 of the radial direction M. The pressure-side cam portions 90 each include the pressure-side assist cam surface 90A (see also FIG. 10) and the pressure-side slipper cam surface 90S. The pressure-side assist cam surface 90A is contactable with the center-side assist cam surface 60A. The pressure-side assist cam surface 90A generates a force in such as direction as to move the pressure structure 70 toward the clutch center 40, in order to increase the pressing force (contact pressure force) between the input-side rotating plates 20 and the output-side rotating plates 22, when the pressure structure 70 rotates with respect to the clutch center 40. The pressure-side slipper cam surface 90S is contactable with the center-side slipper cam surface 60S. The pressure-side slipper cam surface 90S separates the pressure structure 70 from the clutch center 40, to decrease the pressing force (contact pressure force) between the input-side rotating plates 20 and the output-side rotating plates 22, when the pressure structure 70 rotates with respect to the clutch center Regarding two of the pressure-side cam portions 90 adjacent to each other in the circumferential direction S, the pressure-side assist cam surface 90A of one pressure-side cam portion 90L and the pressure-side slipper cam surface 90S of the other pressure-side cam portion 90M are opposed to each other in the circumferential direction S.

Effects of the center-side cam portions 60 and the pressure-side cam portions 90 will now be described. Referring to FIG. 11A, when the rotation speed of the engine increases so that a rotation driving force input to the input gear 35 and the clutch housing 30 is allowed to be transferred to the output shaft 15 through the clutch center 40, a rotation force in the first circumferential direction S1 is applied to the pressure structure 70. Thus, with the effects of the center-side assist cam surface 60A and the pressure-side assist cam surface 90A, a force in the first direction D1 is generated in the pressure structure 70. Accordingly, a contact pressure force between the input-side rotating plates 20 and the output-side rotating plates 22 increases.

By contrast, referring to FIG. 11B, when the rotation speed of the output shaft 15 exceeds the rotation speed of the input gear 35 and the clutch housing 30 and a back torque is generated, a rotation force in the first circumferential direction S1 is applied to the clutch center 40. Thus, with the effects of the center-side slipper cam surface 60S and the pressure-side slipper cam surface 90S, the pressure structure 70 moves in the second direction D2 to release the input-side rotating plates 20 and the output-side rotating plates 22 from the contact pressure force. In this manner, detrimental effects to the engine and the transmission caused by the back torque are preferably avoided. The rotation force in the first circumferential direction S1 is applied to the clutch center 40, and as a result, the first pressure structure 71 and the second pressure structure 81 rotate with respect to each other in the circumferential direction S.

As shown in FIG. 9, the pressure-side fitting portions 88 are located ahead of the pressure-side cam portions 90 in the outward direction M1 of the radial direction M. The pressure-side fitting portions 88 are located ahead of the pressure-side cam portions 90 in the second direction D2. The pressure-side fitting portions 88 are slidably inserted into the center-side fitting portion 54 (see FIG. 4).

As shown in FIG. 9 and FIG. 10, the second pressure structure 81 preferably includes pressure-side cam holes 83H which penetrate a portion of the body 82 and a portion of the flange 98. The pressure-side cam holes 83H are located ahead of the cylindrical portion 80 in the outward direction M1 of the radial direction M. The pressure-side cam holes 83H each extend from a position to the side of the cylindrical portion 80 to a position ahead of the corresponding pressure-side fitting portion 88 in the outward M1 of the radial direction M. The pressure-side cam holes 83H are each provided between the pressure-side assist cam surface 90A of one of two adjacent pressure-side cam portions 90 and the pressure-side slipper cam surface 90S of the other of the two adjacent pressure-side cam portions 90. As seen in the axial direction of the second pressure structure 81, each pressure-side assist cam surface 90A and the corresponding pressure-side cam hole 83H partially overlap each other. The bosses 62 (see FIG. 2) of the first clutch center 41 are respectively inserted into the pressure-side cam holes 83H. The bosses 62 respectively penetrate the pressure-side cam holes 83H.

As shown in FIG. 9, the second pressure structure 81 preferably includes the plurality of pressure-side fitting teeth 87 located on the flange 98. The pressure-side fitting teeth 87 hold the output-side rotating plates 22. The pressure-side fitting teeth 87 project in the first direction D1 from the flange 98. The pressure-side fitting teeth 87 are located ahead of the cylindrical portion 80 in the outward direction M1 of the radial direction M. The pressure-side fitting teeth 87 are located ahead of the pressure-side cam portions 90 in the outward direction M1 of the radial direction M. The pressure-side fitting teeth 87 are located ahead of the pressure-side fitting portions 88 in the outward direction M1 of the radial direction M. The plurality of pressure-side fitting teeth 87 are provided in the circumferential direction S. The plurality of pressure-side fitting teeth 87 are located at an equal interval in the circumferential direction S. In this example embodiment, a portion of the pressure-side fitting teeth 87 is removed, and therefore, the interval corresponding to such removed pressure-side fitting teeth 87 is wider than the other intervals. However, adjacent ones of the other pressure-side fitting teeth 87 are located at an equal interval.

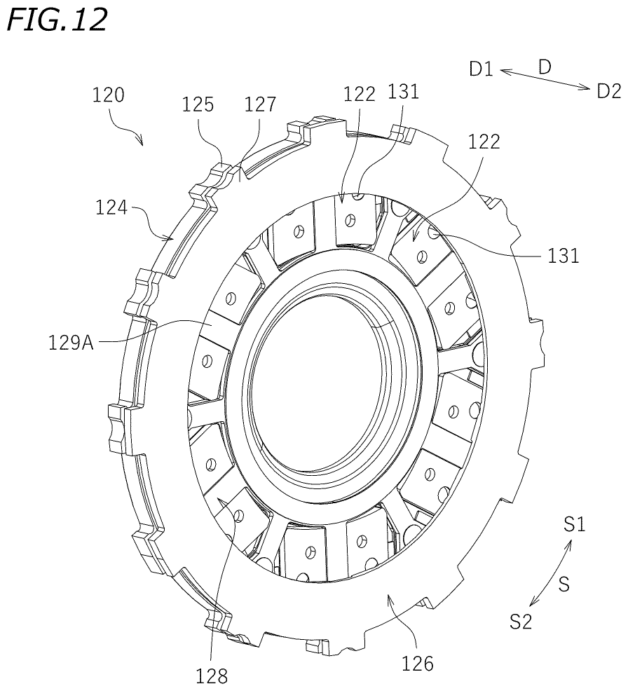

As shown in FIG. 1, spring housings 84 are respectively provided in the pressure-side cam portions 90 (see also FIG. 10). The spring housings 84 are located ahead of the partition wall 80A of the cylindrical portion 80 in the outward direction M1 of the radial direction M. The spring housings 84 are preferably recessed in the first direction D1 from the side of the second direction D2 (see also FIG. 12A). The spring housings 84 are each circular. The spring housings 84 respectively house clutch springs 25.

As shown in FIG. 1, the clutch springs 25 are respectively housed in the spring housings 84. An end of each of the clutch springs 25 on the side of the first direction D1 is in contact with the second pressure structure 81. An end of each of the clutch springs 25 on the side of the second direction D2 is in contact with the corresponding stopper plate 100. The clutch springs 25 urge the pressure structure 70 (more specifically, the second pressure structure 81) toward the clutch center 40 (i.e., in the first direction D1). The clutch springs 25 are preferably, for example, coil springs defined by helically wound spring steel. The clutch springs 25 extend in the direction D.

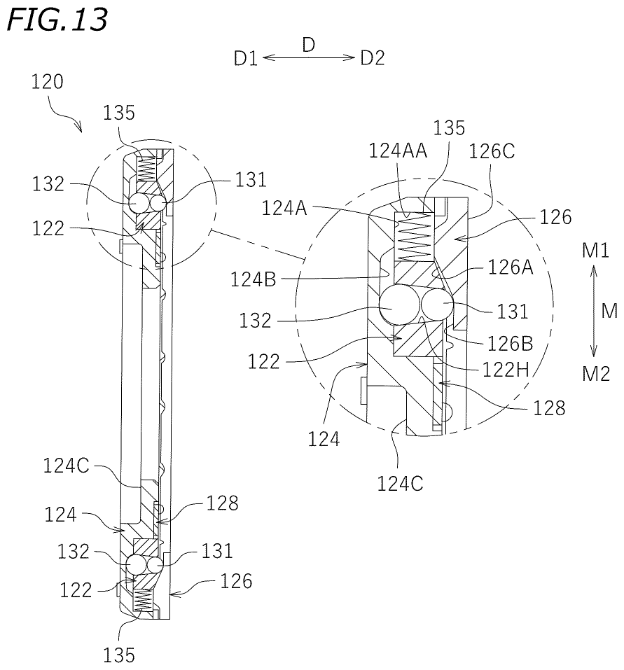

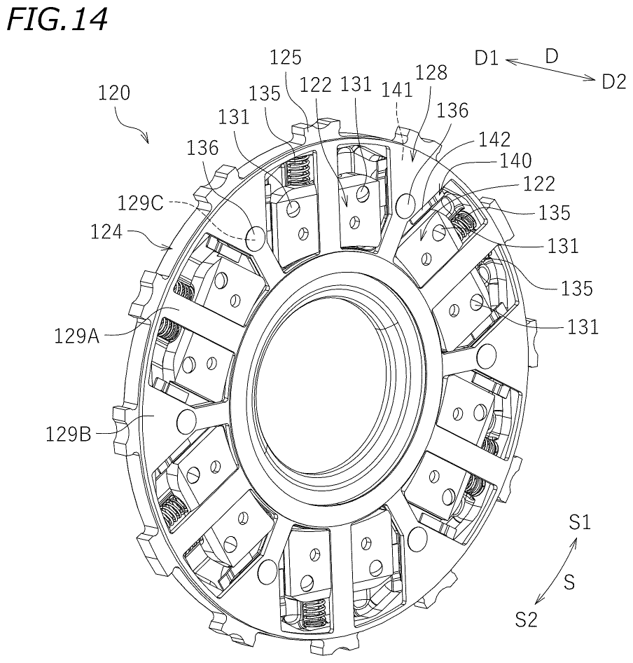

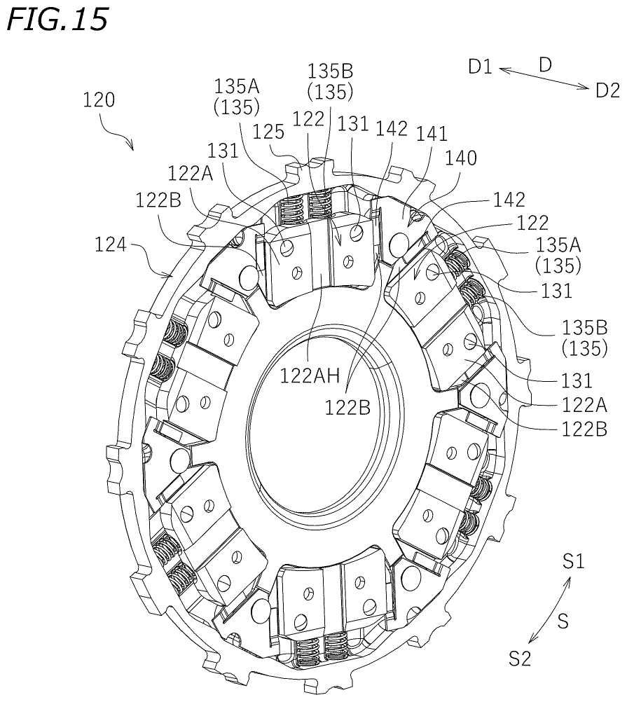

As shown in FIG. 1, the centrifugal clutch mechanism 120 is provided in the clutch housing 30. The centrifugal clutch mechanism 120 is provided ahead of the clutch center 40 in the first direction D1. The centrifugal clutch mechanism 120 is held by the clutch housing 30. The centrifugal clutch mechanism 120 is integrally rotatable with the clutch housing 30. As shown in FIG. 12 and FIG. 13, the centrifugal clutch mechanism 120 preferably includes a plurality of weights 122, a holder 124, a pressure-contact structure 126, a guide 128 (see also FIG. 14), first spherical structures 131, second spherical structures 132, springs 135 (see also FIG. 1), and urging structures 140 (see FIG. 15). When the weights 122 are at outward M1 positions in the radial direction M, the centrifugal clutch mechanism 120 puts the input-side rotating plates 20 and the output-side rotating plates 22 into pressure contact with each other to provide a state where the transfer of the rotation driving force of the input shaft to the output shaft 15 is allowed. When the weights 122 are at inward M2 positions in the radial direction M, the centrifugal clutch mechanism 120 releases the input-side rotating plates 20 and the output-side rotating plates 22 from the contact pressure force to provide a state where the transfer of the rotation driving force of the input shaft to the output shaft 15 is blocked. The centrifugal clutch mechanism 120 is capable of pressing the assisting clutch plate 150 (see FIG. 1).

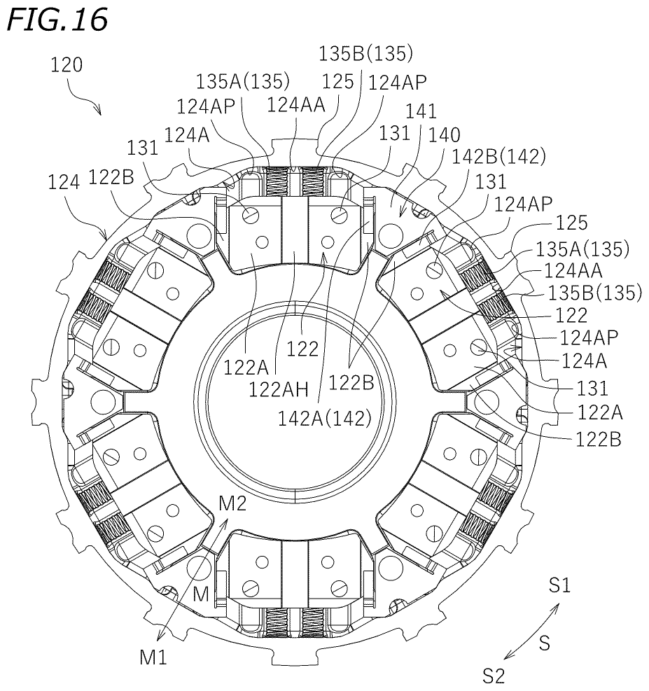

As shown in FIG. 16, the plurality of weights 122 are provided in the circumferential direction S. The weights 122 are movable from the inward M2 positions to the outward M1 positions in the radial direction M by a centrifugal force caused by the rotation of the clutch housing 30. As shown in FIG. 13, the weights 122 are respectively housed in housings 124A, described below, of the holder 124. As shown in FIG. 15, the weights 122 each preferably include a generally cuboid body 122A and planar portions 122B respectively located at both of two ends of the body 122A in the circumferential direction S. The weights 122 each preferably include penetrating holes 122H (see FIG. 13) penetrating the body 122A in the axial direction of the output shaft 15 (i.e., in the direction D). One weight 122 preferably includes two penetrating holes 122H. The planar portions 122B are located ahead of the body 122A in the first direction D1. The planar portions 122B each have a plane perpendicular or substantially perpendicular to the axial direction of the output shaft 15. The planar portions 122B are respectively urged by urging portions 142, described below, of the urging structures 140. In a state of not being provided with a centrifugal force, the weights 122 are held at the inward M2 positions in the radial direction M by the springs 135. When being provided with a centrifugal force, the weights 122 move in the outward direction M1 of the radial direction M against the urging force of the springs 135 to arrive at the outward M1 positions in the radial direction M.

As shown in FIG. 13, the first spherical structures 131 are attached to the weights 122. The first spherical structures 131 are each preferably, for example, a steel sphere. Each first spherical structure 131 partially projects from one opening (in this example embodiment, on the side of the second direction D2) of the corresponding penetrating hole 122H provided in the weight 122 and thus contacts a rolling surface of the pressure-contact structure 126. The second spherical structure 132 are attached to the weights 122. The second spherical structure 132 are each, for example, a steel sphere. Each second spherical structure 132 partially projects from the other opening (in this example embodiment, on the side of the first direction D1) of the corresponding penetrating hole 122H in the weight 122 and thus contacts a rolling surface of the holder 124. The first spherical structures 131 and the second spherical structures 132 are rollable.

As shown in FIG. 1, the springs 135 are located ahead of the weights 122 in the outward direction M1 of the radial direction M. The springs 135 are provided in the holder 124. The springs 135 are respectively housed in the housings 124A (see FIG. 13) of the holder 124. A portion of each of the springs 135 is located in the corresponding weight 122. The springs 135 urge the weights 122 in the inward direction M2 of the radial direction M. The springs 135 are each, for example, a coil spring. As shown in FIG. 16, the springs 135 include first springs 135A and second springs 135B arranged in the circumferential direction S. The first springs 135A and the second springs 135B preferably have the same shape. A pair of the first spring 135A and the second spring 135B are located between a pair of the first spherical structures 131 in the circumferential direction S. The pair of first spherical structures 131 may be located between the pair of the first spring 135A and the second spring 135B in the circumferential direction S. The spring 135 is an example of an elastic structure. The elastic structure may be made of rubber, for example. The first spring 135A is an example of first elastic structure, and the second spring 135B is an example of second elastic structure.

As shown in FIG. 13, the holder 124 holds the weights 122 such that the weights 122 are movable between the inward M2 positions and the outward M1 positions in the radial direction M. The holder 124 is annular. The holder 124 is preferably die-cast with aluminum, for example. The holder 124 includes the plurality of housings 124A arranged in the circumferential direction S, a pressing portion 124C, and engagement projections 125 (see FIG. 14). The housings 124A respectively house the weights 122. The housings 124A are each recessed in correspondence with the shape and the movable range of the weight 122. The housings 124A are each configured such that ends of the springs 135 are contactable with an outer circumferential wall 124AA thereof. The housings 124 each include a contact surface 124B, which contacts the weight 130 when the weight 122 moves in the radial direction M. The contact surface 124B faces the weight 122 in the axial direction of the output shaft 15 (i.e., in the direction D). In this example embodiment, the second spherical structures 132 of the weight 130 contact the contact surface 124B. As shown in FIG. 16, the engagement projections 125 are located ahead of the springs 135 in the outward direction M1 of the radial direction M. The engagement projections 125 project in the outward direction M1 of the radial direction M. The engagement projections 125 are engaged with the clutch housing 30. The plurality of engagement projections 125 are arranged in the circumferential direction S. The holder 124 includes pressed surfaces 124AP, each of which is a portion of the outer circumferential wall 124AA of the corresponding housing 124A and is pressed by the corresponding weight 122 when the weight 122 is at the outward M1 position in the radial direction M. A stress in the outward direction M1 of the radial direction M is applied to the pressed surfaces 124AP by the weight 122. The engagement projections 125 and the pressed surfaces 124AP are located to be shifted from each other in the circumferential direction S. In this example embodiment, the engagement projections 125 are each located between a pair of the pressed surfaces 124AP in the circumferential direction S. The holder 124 is an example of contact structure.

As shown in FIG. 13, the pressure-contact structure 126 is configured to move in the second direction D2 by the movement of the weights 122 from the inward M2 positions to the outward M1 positions in the radial direction M and thus to put the input-side rotating plates 20 and the output-side rotating plates 22 into pressure contact with each other. The pressure-contact structure 126 is annular. The pressure-contact structure 126 includes a plurality of gradient portions 126A provided in the circumferential direction S, grooves 126B respectively located at the positions of the gradient portions 126A, and a pressing surface 126C. The gradient portions 126A are respectively located at positions corresponding to the weights 122. The gradient portions 126A are inclined in the first direction D1 while inclining in the outward direction M1 of the radial direction M from the side of the inward direction M2. In a state where the clutch housing 30 is at a pause, the weights 122 are held at the inward M2 positions by the urging force of the springs 135. In a state where the weights 122 are provided with a centrifugal force as a result of the clutch housing 30 rotating, the weights 122 move along the gradient portions 126A, so that the pressure-contact structure 126 moves in a direction away from the holder 124 (i.e., in the second direction D2). As a result, the pressing surface 126C of the pressure-contact structure 126 presses the flange 68 (see FIG. 1) of the second clutch center 51 in the second direction D2. As shown in FIG. 12, the pressure-contact structure 126 includes a plurality of projections 127 provided in the circumferential direction S. The projections 127 overlap the engagement projections 125 of the holder 124. The projections 127 are engaged with the clutch housing 30. The holder 124 and the pressure-contact structure 126 are held on an inner circumferential surface of the side wall 33 of the clutch housing 30 via the engagement projections 125 and the projections 127, like the input-side rotating plates 20. The holder 124 and the pressure-contact structure 126 are held by the clutch housing 30 through spline fitting. The holder 124 and the pressure-contact structure 126 are provided to be displaceable in the axial direction of the clutch housing (i.e., the direction D). The holder 124 and the pressure-contact structure 126 are provided to be integrally rotatable with the clutch housing 30.

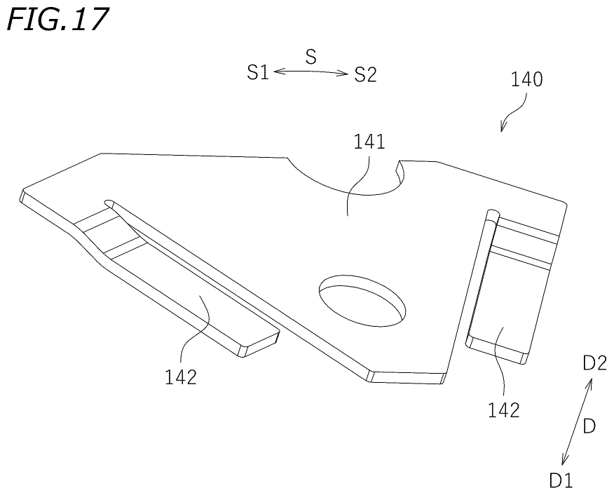

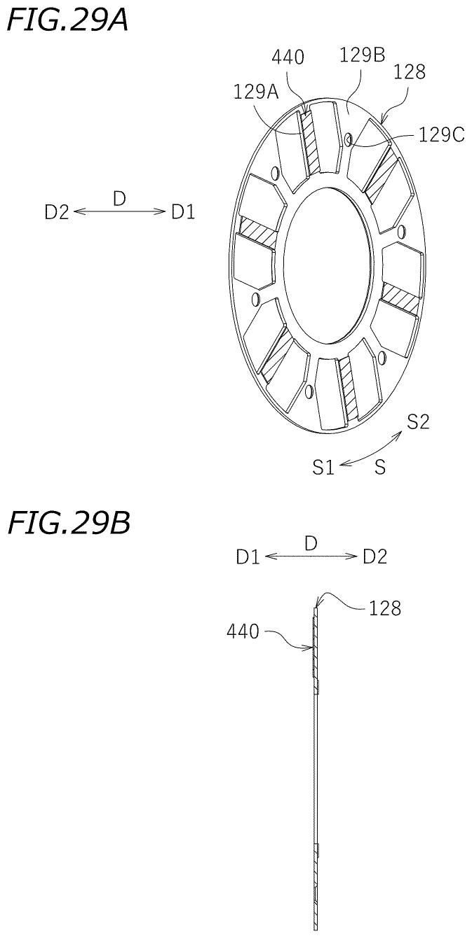

As shown in FIG. 12 and FIG. 13, the guide 128 is located between the holder 124 and the pressure-contact structure 126 in the axial direction of the output shaft 15 (i.e., in the direction D). The guide 128 is attached to the holder 124. The guide 128 is secured to the holder 124. More specifically, the guide 128 is secured to a surface, of the holder 124, in which the housings 124A are provided. The guide 128 holds the weights 122 such that the weights 122 are movable in the radial direction M. The guide 128 guides the movement of the weights 122 in the radial direction M. As shown in FIG. 14, the guide 128 is annular. The guide 128 includes guide portions 129A guiding the movement of the weights 122 and securing portions 129B securing the urging structures 140. The guide portions 129A extend in the radial direction M. The guide portions 129A are respectively fit into grooves 122AH (see FIG. 15) each located at or generally at a center of the body 122A of the corresponding weight 122. The securing portions 129B are each preferably triangular or generally triangular. The securing portions 129B respectively secure secured portions 141 described below (see FIG. 17) of the urging structures 140. The securing portions 129B each include an insertion hole 129C (see FIG. 14 and FIG. 29A) into which a rivet 136 described below is inserted.

The urging structures 140 are located between the holder 124 and the pressure-contact structure 126 in the axial direction of the output shaft 15 (i.e., in the direction D). As shown in FIG. 14, the urging structures 140 are located between the holder 124 and the guide 128 in the axial direction of the output shaft 15 (i.e., in the direction D). The urging structures 140 are provided between the guide 128 and the weights 122. The urging structures 140 are provided on the guide 128. The urging structures 140 are secured to the holder 124. The urging structures 140 are each provided on the guide 128 at a position between adjacent ones of the weights 122. The urging structures 140 are each secured to the holder 124 at a position between adjacent ones of the weights 122. The urging structures 140 are each secured to the holder 124 by the rivet 136, together with the guide 128. The urging structures 140 may each be secured to the holder 124 by a tightening structure such as a bolt or the like, instead of the rivet 136. In this example embodiment, the urging structures 140 are provided separately from the guide 128. The urging structures 140 may be provided integrally with the guide 128. The urging structures 140 urge the weights 122, held by the holder 124, in the axial direction of the output shaft 15. The urging structures 140 urge the weights 122 in the axial direction of the output shaft 15 and toward the contact surfaces 124B (see FIG. 1). The urging structures 140 press ends of the weights 122 in the circumferential direction S. The urging structures 140 constantly urge the weights 122 in the axial direction of the output shaft 15. That is, the urging structures 140 urge the weights 122 in the axial direction of the output shaft 15 in the entire time period from the time when the weights 122 are at the inward M2 positions in the radial direction M until the time when the weights 122 are at the outward M1 positions in the radial direction M. In this example embodiment, the urging structures 140 urge the weights 122 in the first direction D1. The urging structures 140 urge the weights 122 in the axial direction of the output shaft 15 and toward the holder 124. The urging structures 140 press the second spherical structures 132 of the centrifugal clutch mechanism 120 to the holder 124 (in this example embodiment, to the contact surfaces 124B). The urging structures 140 permit the weights 122 to move in the radial direction M.

As shown in FIG. 17, each of the urging structures 140 are preferably defined by plate-shaped structures. The urging structure 140 is preferably made of, for example, an SPCC (Steel Plate Cold Commercial) material. The urging structure 140 is a so-called leaf spring. The urging structure 140 includes the secured portion 141 which is triangular or generally triangular and the urging portions 142 provided ahead of the secured portion 141 in the outward direction M1 of the radial direction M and provided respectively at two ends of the secured portion 141 in the circumferential direction S. The secured portion 141 contacts the holder 124 and the guide 128. The urging portions 142 are located ahead of the secured portion 141 in the first direction D1. The urging portions 142 contact the weights 122. More specifically, the urging portions 142 contact the planar portions 122B (see FIG. 15) of the weights 122. The urging portions 142 urge the weights 122 in the axial direction of the output shaft 15 (i.e., in the direction D). The urging portions 142 urge the weights 122 in the first direction D1. The urging portions 142 are each elastically deformable. As shown in FIG. 16, the urging portions 142 include a first urging portion 142A provided at an end, on the side of the first circumferential direction S1, of the secured portion 141, and a second urging portion 142B provided at an end, on the side of the second circumferential direction S2, of the secured portion 141. The first urging portion 142A urges the planar portion 122B of the weight 122 located ahead of the urging structure 140 in the first circumferential direction S1. The second urging portion 142B urges the planar portion 122B of the weight 122 located ahead of the urging structure 140 in the second circumferential direction S2. In this manner, one urging structure 140 urges a plurality of the weights 122 (in this example embodiment, two weights 122) in the axial direction of the output shaft 15.

In the centrifugal clutch mechanism 120 having such a configuration, when the weights 122 are not provided with a centrifugal force, the weights 122 are held at the inward M2 positions in the radial direction M, and thus the input-side rotating plates 20 and the output-side rotating plates 22 are released from the contact pressure force. By contrast, when the weights 122 are provided with a centrifugal force, the weights 122 move from the inward M2 positions to the outward M1 positions in the radial direction M. At this point, the weights 122 are urged in the first direction D1 by the urging structures 140, and therefore, move smoothly from the inward M2 positions to the outward M1 positions in the radial direction M without vibrating in the axial direction of the output shaft 15 (i.e., in the direction D). As a result, the pressing surface 126C in the pressure-contact structure 126 presses the input-side rotating plates 20 and the output-side rotating plates 22 via the flange 68 of the second clutch center 51 into a contact pressure state, to provide a state where the transfer of the rotation driving force of the input shaft to the output shaft 15 is allowed. At this point, the holder 124 moves in the first direction D1, and the pressing portion 124C in the holder 124 presses the assisting clutch plate 150.

As shown in FIG. 1, the assisting clutch plate 150 is preferably provided in the clutch housing 30. The assisting clutch plate 150 is secured to the output shaft 15. The assisting clutch plate 150 includes an insertion hole 152H into which the output shaft 15 is inserted and with which the output shaft 15 is spline-fitted. The assisting clutch plate 150 is located ahead of a portion of the centrifugal clutch mechanism 120 in the first direction D1. The assisting clutch plate 150 is adjacent to the first clutch center 41.

The assisting clutch plate 150 is pressed by the centrifugal clutch mechanism 120 (in this example embodiment, the pressing portion 124C of the holder 124) when the input-side rotating plates 20 and the output-side rotating plates 22 are in pressure contact with each other (i.e., when the weights 122 of the centrifugal clutch mechanism 120 are located at the outward M1 positions in the radial direction M), thus to provide a state where the transfer of the rotation driving force of the input shaft to the output shaft 15 is allowed. The assisting clutch plate 150 is released from a state of being pressed by the centrifugal clutch mechanism 120 (in this example embodiment, the pressing portion 124C of the holder 124) when the input-side rotating plates 20 and the output-side rotating plates 22 are released from the contact pressure force (i.e., when the weights 122 of the centrifugal clutch mechanism 120 are located at the inward M2 positions in the radial direction M), thus to provide a state where the transfer of the rotation driving force of the input shaft to the output shaft 15 is blocked.

As shown in FIG. 1, the stopper plates 100 are contactable with the pressure structure 70. The stopper plates 100 suppress the movement of the pressure structure 70 away from the clutch center 40 by a predetermined distance or longer in the second direction D2. The stopper plates 100 are respectively secured to the bosses 62 of the first clutch center 41 by the bolts 28. In a state where the clutch springs 25 are located in the spring housings 84, the pressure structure 70 is secured to the clutch center 40 by the bolts 28 being tightened to the bosses 62 via the stopper plates 100. The stopper plates 100 are preferably ring-shaped as seen in a plan view.

As described above, in the clutch device 10 according to this example the urging structures 140 of the centrifugal clutch mechanism 120 are located between the holder 124 and the pressure-contact structure 126 in the axial direction of the output shaft 15, and urge the weights 122 held by the holder 124 in the axial direction of the output shaft 15 and also permit the weights 122 to move in the radial direction M. According to this example embodiment, the weights 122 are urged by the urging structures 140 in the axial direction of the output shaft 15, and therefore, the vibration of the weights 122 in the axial direction of the output shaft 15 is reduced or minimized even though the engine or the like vibrates. As a result, the weights 122 move smoothly in the radial direction M. Therefore, the thrust in the axial direction of the output shaft 15, generated in the weights 122 by the centrifugal force caused by the rotation of the clutch housing 30, is effectively transferred to the pressure-contact structure 126.

In the clutch device 10 according to this example embodiment, the urging structures 140 are preferably each plate-shaped structures. According to this example embodiment, the urging structures 140, which have a simple configuration, urge the weights 122 in the axial direction of the output shaft 15.

The clutch device 10 according to this example embodiment includes the guide 128 located between the holder 124 and the pressure-contact structure 126 in the axial direction of the output shaft 15 and guiding the movement of the weights 122 in the radial direction M. The urging structures 140 are provided on the guide 128. According to this example embodiment, the urging structures 140 urge predetermined portions of the weights 122 in the axial direction of the output shaft 15 more certainly.

In the clutch device 10 according to this example embodiment, the urging structures 140 are secured to the holder 124. According to this example embodiment, the urging structures 140 are secured to the holder 124, and therefore, urge predetermined portions of the weights 122 in the axial direction of the output shaft 15 more certainly.

In the clutch device 10 according to this example embodiment, the urging structures 140 each include the urging portions 142 urging the weights 122 in the axial direction of the output shaft 15, and the urging portions 142 are elastically deformable. According to this example embodiment, excessive urging of the weights 122 by the urging portions 142 is reduced or minimized.

In the clutch device 10 according to this example embodiment, one urging structure 140 includes the urging portions 142 respectively at an end on one side in the circumferential direction S (on the side of the first circumferential direction S1) of the urging structure 140 and an end on the other side in the circumferential direction S (on the side of the second circumferential direction S2) of the urging structure 140. According to this example embodiment, the urging portions 142 urge the weights 122 in the axial direction of the output shaft 15.

In the clutch device 10 according to this example embodiment, the weights 122 each include the planar portions 122B urged by the urging portions 142. According to this example embodiment, the urging force of the urging portions 142 is transferred to the weights 122 more effectively.

In the clutch device 10 according to this example embodiment, one urging structure 140 urges a plurality of the weights 122 in the axial direction of the output shaft 15. According to this example embodiment, the centrifugal clutch mechanism 120 is simplified.

In the clutch device 10 according to this example embodiment, the plurality of weights 122 are provided in the circumferential direction S, and the urging structures 140 are each provided on the guide 128 between adjacent ones of the weights 122. According to this example embodiment, the urging structures 140 are located in a compact manner.

In the clutch device 10 according to this example embodiment, the urging structures 140 are each secured to the holder 124 between adjacent ones of the weights 122. According to this example embodiment, the urging structures 140 are located in a compact manner.

In the clutch device 10 according to this example embodiment, the holder 124 includes the engagement projections 125 located ahead of the springs 135 in the outward direction M1 of the radial direction M and engaged with the clutch housing 30, and the pressed surfaces 124AP pressed by the weights 122 when the weights 122 are at the outward M1 positions in the radial direction M. The engagement projections 125 and the pressed surfaces 124AP are located to be shifted from each other in the circumferential direction S. According to this example embodiment, the engagement projections 125 are not provided with an excessive load, and therefore, destruction of the engagement projections 125 is reduced or minimized.

In the clutch device 10 according to this example embodiment, the weights 22 each include the plurality of penetrating holes 122H penetrating the weight 22 in the axial direction of the output shaft 15. The springs 135 include the first springs 135A and the second springs 135B arranged in the circumferential direction S. The centrifugal clutch mechanism 120 includes the first spherical structures 131 each partially projecting from the opening of the corresponding penetrating hole 122H and configured to be rollable. The first spherical structures 131 may be located between the first spring 135A and the second spring 135B in the circumferential direction S. According to this example embodiment, the first spring 135A and the second spring 135B urge the weight 122 in the inward direction M2 of the radial direction M with a good balance.

In the clutch device 10 according to this example embodiment, the urging structures 140 urge the weights 122 in the axial direction of the output shaft 15 and toward the holder 124. According to this example embodiment, the weights 122 are constantly in contact with the holder 124 by the urging structures 140. Therefore, even though the engine or the like vibrates, the vibration of the weights 122 in the axial direction of the output shaft 15 is reduced or minimized more certainly.

### Example Embodiment 2

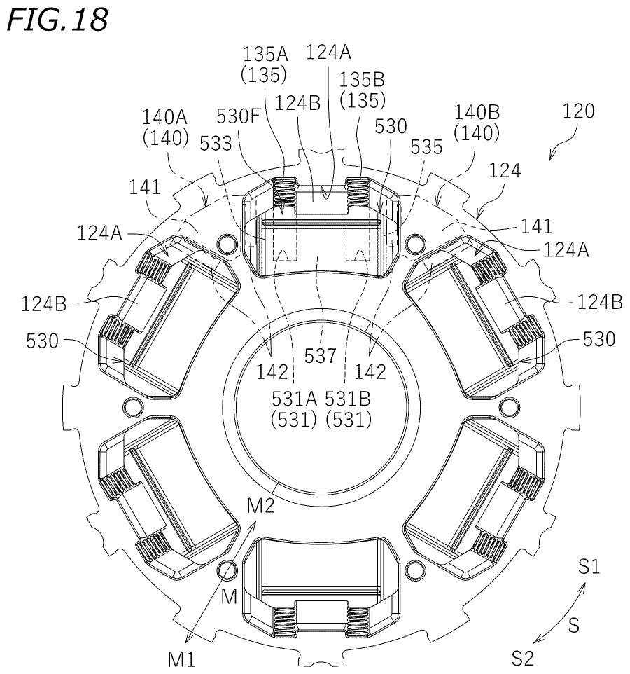

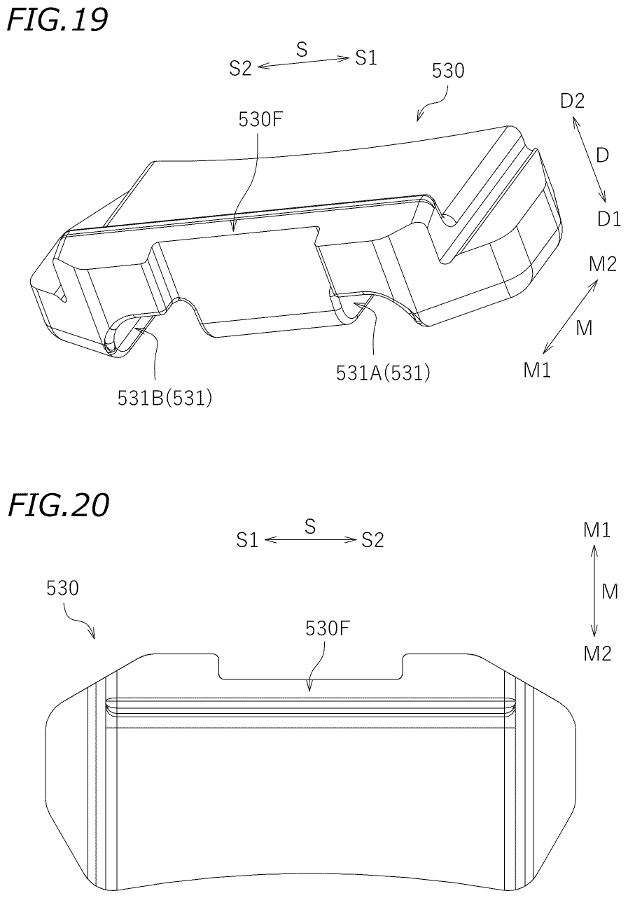

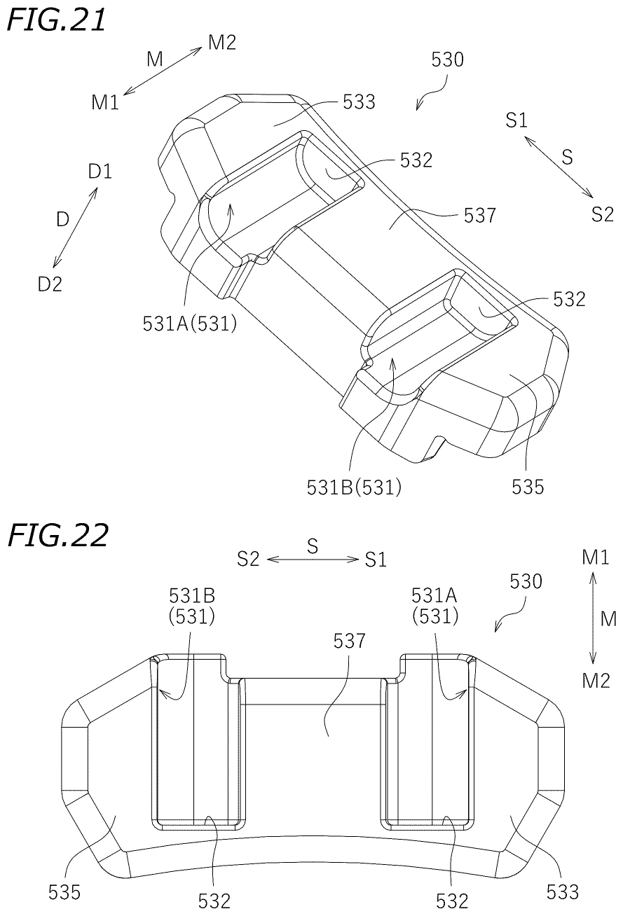

FIG. 18 is a plan view showing a portion of a centrifugal clutch mechanism 120 according to example embodiment 2, showing a state where weights 530 are located at inward M2 positions in the radial direction M. As shown in FIG. 18, the plurality of weights 530 are provided in the circumferential direction S. The weights 530 are movable from the inward M2 positions to outward M1 positions in the radial direction by a centrifugal force caused by the rotation of the clutch housing 30. The weights 530 are capable of pressing the pressure-contact structure 126 in the second direction D2. In a state of not being provided with a centrifugal force, the weights 530 are held at the inward M2 positions in the radial direction M by the springs 135. When being provided with a centrifugal force, the weights 530 move in the outward direction M1 of the radial direction M against the urging force of the springs 135 to arrive at the outward M1 positions in the radial direction M. The weights 530 are respectively housed in the housings 124A of the holder 124. As shown in FIG. 21, each of the weights 530 includes urging structure holding portions 531, a first plane 533 provided ahead of the urging structure holding portions 531 on one side in the circumferential direction S, a second plane 535 provided ahead of the urging structure holding portions 531 on the other side in the circumferential direction S, and a weight-side inclining surface 530F (see FIG. 19 and FIG. 20) located opposite to the first plane 533 and the second plane 535 in the axial direction of the output shaft 15 (i.e., in the direction D).

The urging structure holding portions 531 hold the springs 135. As shown in FIG. 21, the urging structure holding portions 531 are recessed grooves recessed in the second direction D2 while inclining in the inward direction M2 from the side of the outward direction M1 of the radial direction M. The urging structure holding portions 531 each include a holding wall 532 holding an end, on the side of the inward direction M2 of the radial direction M, of the spring 135. In this example embodiment, the urging structure holding portions 531 include a first urging structure holding portion 531A holding the first spring 135A (see FIG. 18) and a second urging structure holding portion 531B holding the second spring 135B.

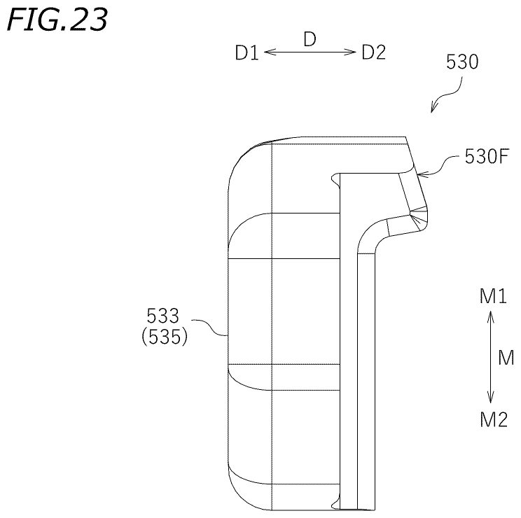

As shown in FIG. 21 and FIG. 22, the first plane 533 is provided ahead of the urging structure holding portions 531 in the first circumferential direction S1. More specifically, the first plane 533 is provided ahead of the first urging structure holding portion 531A in the first circumferential direction S1. The first plane 533 is provided side by side with the first urging structure holding portion 531A in the circumferential direction S. The second plane 535 is provided ahead of the urging structure holding portions 531 in the second circumferential direction S2. More specifically, the second plane 535 is provided ahead of the second urging structure holding portion 531B in the second circumferential direction S2. The second plane 535 is provided side by side with the second urging structure holding portion 531B in the circumferential direction S. As shown in FIG. 23, the first plane 533 and the second plane 535 are perpendicular or substantially perpendicular to the axial direction of the output shaft 15 (i.e., in the direction D). The first plane 533 and the second plane 535 are preferably flush with each other. The first plane 533 and the second plane 535 are contactable with the contact surface 124B of the holder 124. The first plane 533 and the second plane 535 are provided to be slidable against the holder 124. More specifically, the first plane 533 and the second plane 535 are slidable against the contact surface 124B.

As shown in FIG. 21, the weight 530 preferably includes a third plane 537. The third plane 537 is located between the first plane 533 and the second plane 535 in the circumferential direction S. The third plane 537 is located between the first urging structure holding portion 531A and the second urging structure holding portion 531B in the circumferential direction S. The third plane 537 may be slidable against the holder 124. The third plane 537 may be flush with the first plane 533 and the second plane 535.

The weight-side inclining surface 530F is contactable with the pressure-contact structure 126. As shown in FIG. 23, the weight-side inclining surface 530F is inclined with respect to the axial direction of the output shaft 15 (i.e., with respect to the direction D). The weight-side inclining surface 530F is inclined in the first direction D1 while inclining in the outward direction M1 from the side of the inward direction M2 of the radial direction M. The weight-side inclining surface 530F is slidable against the gradient portion 126A (see FIG. 13) of the pressure contact portion 126.

As shown in FIG. 18, the urging structures 140 urge the weights 530 in the axial direction of the output shaft 15 (i.e., in the direction D) and toward the contact surfaces 124B. The urging portions 142 of the urging structures 140 contact the weights 530. In a state where the weights 530 are located at least at the inward M2 positions in the radial direction M, as seen in the axial direction of the output shaft 15, the secured portion 141 of each of urging structures 140A is located ahead of the first plane 533 on a side in the circumferential direction S (on the side of the first circumferential direction S1), and one of the urging portions 142 of the urging structure 140A overlaps at least a portion of the first plane 533. In a state where the weights 530 are located at least at the inward M2 positions in the radial direction M, as seen in the axial direction of the output shaft 15, the secured portion 141 of each of urging structures 140B is located ahead of the second plane 535 on a side in the circumferential direction (on the side of the second circumferential direction S2), and one of the urging portions 142 of the urging structure 140B overlaps at least a portion of the second plane 535. It may be configured such that in at least a state during the movement of the weights 530 in the outward direction from the side of the inward direction M2 of the radial direction M, and in a state where the weights 530 are located at the outward M1 positions in the radial direction M, as seen in the axial direction of the output shaft 15, one of the urging portions 142 of the urging structure 140A overlaps at least a portion of the first plane 533, and one of the urging portions 142 of the urging structure 140B overlaps at least a portion of the second plane 535.

In the centrifugal clutch mechanism 120 including such a configuration, as shown in FIG. 18, when the weights 530 are not provided with a centrifugal force, the weights 530 are held at the inward M2 positions in the radial direction M, and thus the input-side rotating plates 20 and the output-side rotating plates 22 are released from the contact pressure force. By contrast, when the weights 530 are provided with a centrifugal force, the weights 530 move from the inward M2 positions to the outward M1 positions in the radial direction M. While the weights 530 move in the radial direction M, the weight-side inclining surfaces 530F of the weights 530 and the gradient: portions 126A of the pressure-contact structure 126 slide against each other, and furthermore, the first planes 533 and the second planes 535 of the weights 530 slide against the contact surfaces 124B of the holder 124. At this point, the pressing surface 126C (see FIG. 13) of the pressure-contact structure 126 presses the input-side rotating plates 20 and the output-side rotating plates 22 via the flange 68 of the second clutch center 51 into a contact pressure state, to provide a state where the transfer of the rotation driving force of the input shaft to the output shaft 15 is allowed. At the same time, the holder 124 moves in the first direction D1, and the pressing portion 124C (see FIG. 13) of the holder 124 presses the assisting clutch plate 150.

### Example Embodiment 3

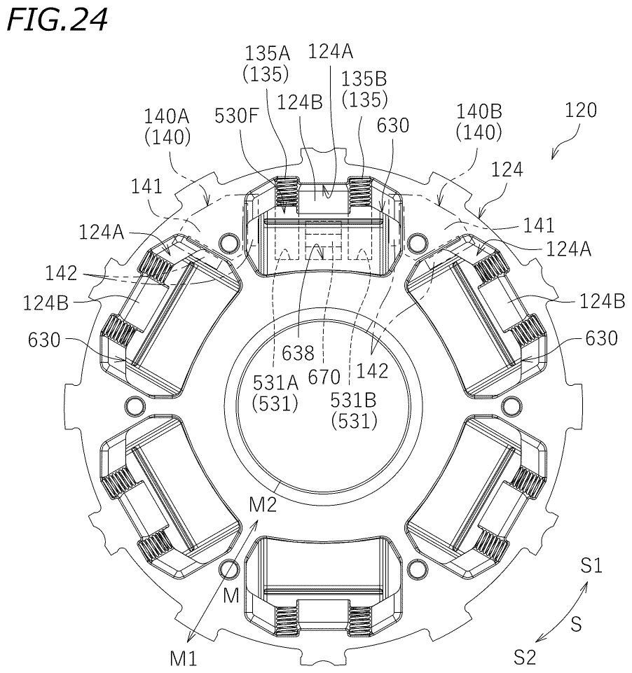

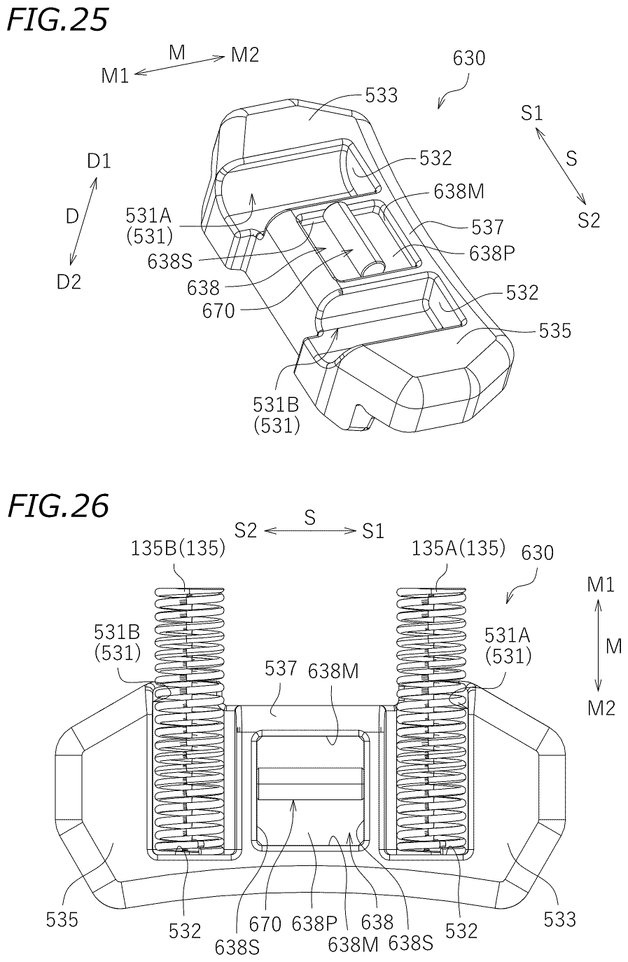

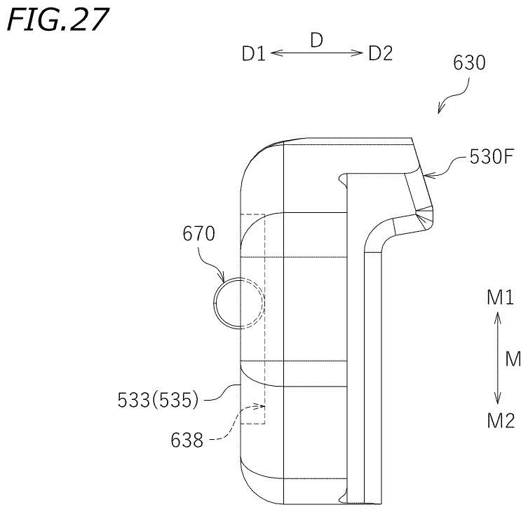

FIG. 24 is a plan view showing a portion of a centrifugal clutch mechanism 120 according to example embodiment 3, showing a state where weights 630 are located at inward M2 positions in the radial direction M. As shown in FIG. 24, the plurality of weights 630 are provided in the circumferential direction S. As shown in FIG. 25, the weights 630 each include a guide portion 638 housing a portion of a cylindrical structure 670. The guide portion 638 is provided in a surface opposing the holder 124 (in this example embodiment, in the third plane 537). The guide portion 638 holds the cylindrical structure 670 such that a portion of the cylindrical structure 670 projects toward the holder 124 from a surface, of the weight 630, that opposes the holder 124 (in this example embodiment, the surface is the third plane 537) (i.e., the portion of the cylindrical structure 670 projects in the first direction D1) (see FIG. 27). The guide portion 638 guides a movement of the cylindrical structure 670 in the radial direction M. The guide portion 638 is located between the first urging structure holding portion 531A and the second urging structure holding portion 531B in the circumferential direction S. As shown in FIG. 26, the guide portion 638 is rectangular as seen in a plan view. The guide portion 638 includes first restriction portions 638S restricting the cylindrical structure 670 from moving in the circumferential direction S and second restriction portions 638M restricting the cylindrical structure 670 from moving in the radial direction M by a predetermined distance or longer. The first restriction portions 638S are respectively provided on the side of the first circumferential direction S1 and the side of the second circumferential direction S2 of the circumferential direction S. The second restriction portions 638M are respectively provided on the side of the outward direction M1 and on the side of the inward direction M2 of the radial direction M. The guide portion 638 includes a housing recessed groove 638P recessed toward the weight 630 from the holder 124 in the axial direction of the output shaft 15 (i.e., in the direction D) (i.e., the housing recessed groove 638P is recessed in the second direction D2) and housing a portion of the cylindrical structure 670. The housing recessed groove 638P is defined by the first restriction portions 638S and the second restriction portions 638M.

As shown in FIG. 24, the cylindrical structures 670 are each provided between the weight 630 and the holder 124 in the axial direction of the output shaft 15 (i.e., in the direction D). The cylindrical structure 670 is located to extend in a direction crossing the radial direction M (in this example embodiment, in a direction perpendicular or substantially perpendicular to the radial direction M and the direction D). The cylindrical structure 670 rolls against the weight 630 and the holder 124. A portion of the cylindrical structure 670 is housed in the housing portion 124A of the holder 124, and another portion of the cylindrical structure 670 is housed in the guide portion 638 of the weight 630. The cylindrical structure 670 rolls against the contact surface 124B of the housing portion 124A and the guide portion 638. As shown in FIG. 26, the cylindrical structure 670 is located between the first spring 135A and the second spring 135B in the circumferential direction S.

As shown in FIG. 24, the urging structures 140 urge the weights 630 in the axial direction of the output shaft 15 (i.e., in the direction D) and toward the contact surfaces 124B. The urging portions 142 of the urging structures 140 each contact the corresponding weight 630. In a state where the weights 630 are located at least at the inward M2 positions in the radial direction M, as seen in the axial direction of the output shaft 15, one of the urging portions 142 of each urging structure 140A is located ahead of the guide portion 638 on a side in the circumferential direction S (on the side of the first circumferential direction S1), and one of the urging portions 142 of each urging structure 140B is located ahead of the guide portion 638 on a side in the circumferential direction S (on the side of the second circumferential direction S2). In at least a state during the movement of the weights 630 in the outward direction M1 from the side of the inward direction M2 of the radial direction M, and in a state where the weights 630 are located at the outward M1 positions in the radial direction M, as seen in the axial direction of the output shaft 15, one of the urging portions 142 of the urging structure 140A may be located ahead of the guide portion 638 on a side in the circumferential direction S (on the side of the first circumferential direction S1), and one of the urging portions 142 of the urging structure 140B may be located ahead of the guide portion 638 at a side in the circumferential direction S (on the side of the second circumferential direction S2).

In the centrifugal clutch mechanism 120 with such a configuration, as shown in FIG. 24, when the weights 630 are not provided with a centrifugal force, the weights 630 are held at the inward M2 positions in the radial direction M, and thus the input-side rotating plates 20 and the output-side rotating plates 22 are released from the contact pressure force. By contrast, when the weights 630 are provided with a centrifugal force, the weights 630 move from the inward M2 positions to the outward M1 positions in the radial direction M. While the weights 630 move in the radial direction M, the cylindrical structures 670 are guided by the guide portions 638 and the housing portions 124A to roll against the weights 630 and the holder 124. At this point, the first planes 533 and the second planes 535 of the weights 630 do not slide against the contact surfaces 124B of the holder 124.

### Example Embodiment 4

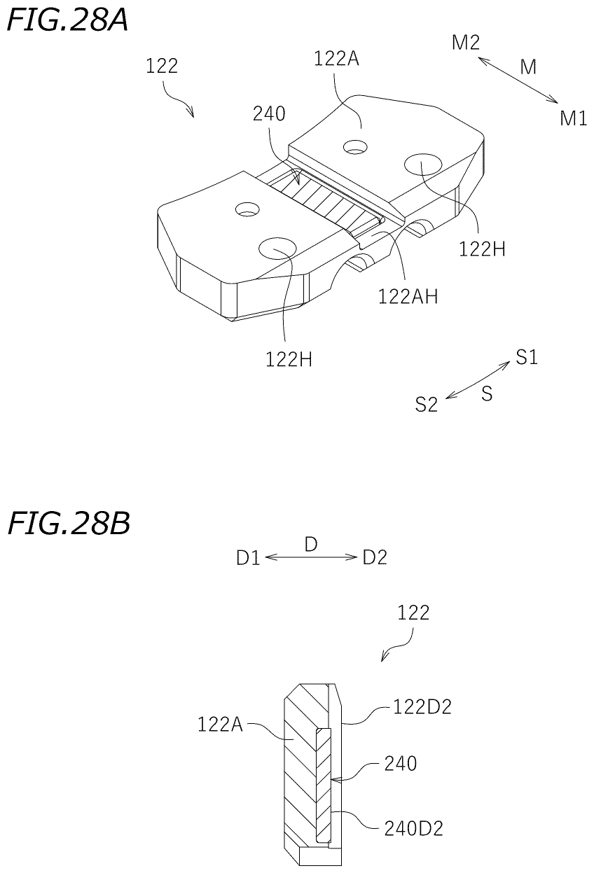

As shown in FIG. 28A and FIG. 28B, an urging structure 240 according to example embodiment 4 is provided in the weight 122. The urging structure 240 is provided between the guide 128 and the weight 122. The urging structure 240 is provided between the guide portion 129A (see FIG. 14) of the guide 128 and the groove 122AH of the weight 122. The urging structure 240 is provided ahead of the weight 122 in the second direction D2. The urging structure 240 is provided at a center of the weight 122 in the circumferential direction S. The urging structure 240 is attached to the groove 122AH of the body 122A of the weight 122. The urging structure 240 is located between the pair of penetrating holes 122H in the circumferential direction S. At least a portion of the urging structure 240 is located ahead of the first spherical structures 131 and the second spherical structures 132 (i.e., the penetrating holes 122H) in the inward direction M2 of the radial direction M. The urging structure 240 is preferably defined by an elastic body. The urging structure 240 is preferably made of, for example, rubber or is, for example, a leaf spring. The urging structure 240 extends in the radial direction M. The urging structure 240 preferably has a cuboid shape. A length of the urging structure 240 in the radial direction M is longer than a length thereof in the circumferential direction S. The urging structure 240 contacts the guide portion 129A (see FIG. 14) of the guide 128. The urging structure 240 contacts the guide 128 to urge the weight 122 in the first direction D1. The urging structure 240 urges the weight 122 in the axial direction of the output shaft 15 and toward the holder 124. In a state before the guide 128 is attached to the holder 124, a surface 240D2, on the side of the second direction D2, of the urging structure 240 projects in the second direction D2 to be ahead of a surface 122D2, on the side of the second direction D2, of the weight 122. In a state where the guide 128 is attached to the holder 124, the urging structure 240 is compressed in the first direction D1. At this point, the surface 240D2, on the side of the second direction D2, of the urging structure 240 may be flush with the surface 122D2, on the side of the second direction D2, of the weight 122 or may project in the second direction D2 to be ahead of the surface 122D2, on the side of the second direction D2, of the weight 122 (in either case, the urging structure 240 urges the weight 122 in the axial direction of the output shaft 15 and toward the holder 124).

In the clutch device 10 according to this example embodiment, the urging structure 240 is made of an elastic body. According to this example embodiment, excessive urging of the weight 122 by the urging structure 240 is reduced or minimized.

In the clutch device 10 according to this example embodiment, the urging structure 240 is provided in the weight 122. According to this example embodiment, the urging structure 240 urges a predetermined portion of the weight 122 in the axial direction of the output shaft 15 more certainly.

In the clutch device 10 according to this example embodiment, the urging structure 240 is provided at a center of the weight 122 in the circumferential direction S. According to this example embodiment, the urging structure 240 urges the weight 122 in the axial direction of the output shaft 15 with a good balance.

In the clutch device 10 according to this example embodiment, the urging structure 240 extends in the radial direction M. According to this example embodiment, the urging structure 240 urges the weight 122 in the axial direction of the output shaft 15 with a better balance.

In the clutch device 10 according to this example embodiment, at least a portion of the urging structure 240 is located ahead of the first spherical structures 131 and the second spherical structures 132 in the inward direction M2 of the radial direction M. According to this example embodiment, the urging structure 240 urges the weight 122 in the axial direction of the output shaft 15 with a better balance.

In this example embodiment, the urging structure 240 is provided at the surface, on the side of the second direction D2, of the weight 122. The present invention is not limited to this. For example, the urging structure 240 may be provided at a surface, on the side of the first direction D1, of the weight 122 to urge the weight 122 in the axial direction of the output shaft 15 and toward the guide 128. With this configuration, the weight 122 is constantly in contact with the guide 128 by the urging structure 240. Therefore, even though the engine or the like vibrates, the vibration of the weight 122 in the axial direction of the output shaft 15 is reduced or minimized more certainly.

### Example Embodiment 5

As shown in FIG. 29A and FIG. 29B, urging structures 440 according to example embodiment 5 are provided on the guide 128. The urging structures 440 are provided ahead of the guide 128 in the first direction D1. The urging structures 440 are respectively provided on guide portions 129A of the guide 128. The urging structures 440 are each provided between a pair of the first spherical structures 131 in the circumferential direction S. The urging structures 440 are each defined by an elastic body. The urging structures 440 are preferably made of, for example, rubber. The urging structures 440 extend in the radial direction M. The urging structures 440 are each flat plate-shaped structures. The urging structures 440 respectively contact the weights 122. The urging structures 440 are each fit into the groove 122AH of the body 122A of the weight 122 to contact the body 122A. The urging structures 440 contact the weights 122 to urge the weights 122 in the first direction D1. The urging structures 440 urge the weights 122 in the axial direction of the output shaft 15 and toward the holder 124.

In the clutch device 10 according to this example embodiment, the centrifugal clutch mechanism 120 includes the guide 128 located between the holder 124 and the pressure-contact structure 126 in the axial direction of the output shaft 15 and guiding the movement of the weights 122 in the radial direction M, and the urging structures 440 are provided on the guide 128. According to this example embodiment, the urging structures 440 urge predetermined portions of the weights 122 in the axial direction of the output shaft 15 more certainly.

In the clutch device 10 according to this example embodiment, the weights 122 each include the plurality of penetrating holes 122H penetrating the weight 122 in the axial direction of the output shaft 15. The centrifugal clutch mechanism 120 includes the pair of first spherical structures 131 partially projecting from the openings of the penetrating holes 122H and configured to be rollable. The urging structures 440 are each located between the pair of spherical structures 131 in the circumferential direction S and extend in the radial direction M. According to this example embodiment, the urging structures 440 urge the weights 122 in the axial direction of the output shaft 15 with a better balance.

Example embodiments of the present invention are described above. The above-described example embodiments are merely illustrative examples, and the present invention may be carried out in any of various other example embodiments.

In each of the above-described example embodiments, the weights 122 each include the planar portions 122B respectively located at the two ends of the body 122A in the circumferential direction S. The present invention is not limited to this. The weights 122 may each include curved portions instead of the planar portions.

In each of the above-described example embodiments, the urging portions 142 of the urging structures 140 urge the planar portions 122B of the weights 122. The urging portions 142 may urge the body 122A instead of the planar portions 122B.

In the above-described example embodiments, the pressure-contact structure 126 is provided separately from the clutch center 40. For example, the pressure-contact structure 126 may be integrally provided with the second clutch center 51. For example, the pressure-contact structure 126 may be integrally provided with the flange 68 of the second clutch center 51.

In the above-described example embodiments, the urging structures 140, 240 and 440 are provided between the guide 128 and the weights 122. The present invention is not limited to this. For example, the urging structures 140, 240 and 440 may be provided between the holder 124 and the weights 122. In this case, the urging structures 140, 240 and 440 urge the weights 122 in the axial direction of the output shaft 15 and toward the pressure-contact structure 126. The urging structures 140, 240 and 440 push the first spherical structures 131 of the centrifugal clutch mechanism 120 to the pressure-contact structure 126. In this case, the pressure-contact structure 126 is an example of contact structure.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A clutch device to allow or block transfer of a rotation driving force of an input shaft to an output shaft, the clutch device comprising:
a clutch center housed in a clutch housing to hold a plurality of input-side rotating plates rotationally drivable by rotational driving of the input shaft, the clutch center being rotationally drivable together with the output shaft;
a pressure structure movable toward, or away from, the clutch center to press the input-side rotating plates and the output-side rotating plates alternately arranged with the input-side rotating plates; and
a centrifugal clutch mechanism including weights movable from radially inward positions to radially outward positions by a centrifugal force caused by the rotation of the clutch housing;
the centrifugal clutch mechanism is configured to put the input-side rotating plates and the output-side rotating plates into pressure contact with each other to provide a state where the transfer of the rotation driving force of the input shaft to the output shaft is allowed when the weights are at the radially outward positions;
the centrifugal clutch mechanism is configured to release the input-side rotating plates and the output-side rotating plates from a contact pressure force to provide a state where the transfer of the rotation driving force of the input shaft to the output shaft is blocked when the weights are at the radially inward positions; and
the centrifugal clutch mechanism includes:
a holder to hold the weights such that the weights are movable between the radially inward positions and the radially outward positions;
an elastic structure urging the weights in a radially inward direction;
a pressure-contact structure movable in an axial direction of the output shaft, by the movement of the weights from the radially inward positions to the radially output positions, to put the input-side rotating plates and the output-side rotating plates into pressure contact with each other; and
an urging structure located between the holder and the pressure-contact structure in the axial direction of the output shaft, the urging structure urging the weight held by the holder in the axial direction of the output shaft and permitting the weight to move in a radial direction.

2. The clutch device according to claim 1, wherein the urging structure is a plate-shaped structure.

3. The clutch device according to claim 2, wherein
the centrifugal clutch mechanism includes a guide located between the holder and the pressure-contact structure in the axial direction of the output shaft to guide the movement of the weights in the radial direction; and
the urging structure is provided on the guide.

4. The clutch device according to claim 3, wherein the urging structure is secured to the holder.

5. The clutch device according to claim 2, wherein:
the urging structure includes an urging portion urging the weight in the axial direction of the output shaft; and
the urging portion is elastically deformable.

6. The clutch device according to claim 5, wherein the urging structure includes the urging portion provided at both an end of the urging structure on one side of a circumferential direction, and another end of the urging structure on another side of the circumferential direction.

7. The clutch device according to claim 5, wherein the weights each include a planar portion urged by the urging portion.

8. The clutch device according to claim 3, wherein the urging structure urges a plurality of the weights in the axial direction of the output shaft.

9. The clutch device according to claim 3, wherein
the plurality of weights are provided in a circumferential direction; and
the urging structure is provided on the guide between adjacent ones of the weights.

10. The clutch device according to claim 9, wherein the urging structure is secured to the holder between adjacent ones of the weights.

11. The clutch device according to claim 2, wherein
the centrifugal clutch mechanism includes a guide located between the holder and the pressure-contact structure in the axial direction of the output shaft to guide the movement of the weights in the radial direction; and
the urging structure is provided between the guide and the weights.

12. The clutch device according to claim 1, wherein the urging structure is in the weight.

13. The clutch device according to claim 1, wherein the urging structure urges a circumferential center portion of the weight in the axial direction.

14. The clutch device according to claim 1, wherein
the weights each include penetrating holes penetrating the weight in the axial direction of the output shaft;
the centrifugal clutch mechanism includes a pair of rollable spherical structures partially projecting from openings of the penetrating holes; and
the urging structure is located between the pair of spherical structures in a circumferential direction and extends in the radial direction.

15. The clutch device according to claim 1, wherein the urging structure urges the weight in the axial direction of the output shaft and toward the holder.

16. The clutch device according to claim 1, wherein
the holder includes a contact surface opposing the weight in the axial direction of the output shaft and contacted by the weight; and
the urging structure urges the weight in the axial direction of the output shaft and toward the contact surface.

17. The clutch device according to claim 16, wherein
the weight includes a plane contactable with the contact surface; and
in a state where the weight is located at least at the radially inward position, as seen in the axial direction of the output shaft, at least a portion of the urging structure is located on one side, in a circumferential direction, of the plane.

18. The clutch device according to claim 17, wherein in a state where the weight is located at least at the radially inward position, as seen in the axial direction of the output shaft, at least a portion of each of a plurality of the urging structures is located on each of two sides of the plane in the circumferential direction.

19. The clutch device according to claim 16, wherein
the weight includes a plane contactable with the contact surface;
the urging structure includes an urging portion contacting the weight; and
in a state where the weight is located at least at the radially inward position, as seen in the axial direction of the output shaft, the urging portion overlaps at least a portion of the plane.

20. The clutch device according to claim 16, wherein
the centrifugal clutch mechanism includes a cylindrical structure provided between the weight and the holder in the axial direction of the output shaft, extending in a direction crossing the radial direction, and rollable against the weight and the holder;
the weight includes:
a guide portion on a surface opposing the holder, the guide portion holding the cylindrical structure such that the cylindrical structure partially project toward the holder from a surface of the weight opposing the holder to guide the movement of the cylindrical structure in the radial direction;
the urging structure includes an urging portion contactable with the weight; and
in a state where the weight is located at least at the radially inward position, as seen in the axial direction of the output shaft, the urging portion is located on one side of the guide portion in a circumferential direction.

21. The clutch device according to claim 20, wherein in a state where the weight is located at least at the radially inward position, as seen in the axial direction of the output shaft, a plurality of the urging portions are respectively located on two sides of the guide portion in the circumferential direction.

22. A clutch device to allow or block transfer of a rotation driving force of an input shaft to an output shaft, the clutch device comprising:
a clutch center housed in a clutch housing holding input-side rotating plates rotatably drivable by rotational driving of the input shaft, the clutch center being rotationally drivable together with the output shaft;
a pressure structure movable toward, or away from, the clutch center, the pressure structure capable of pressing the input-side rotating plates and the output-side rotating plates alternately provided with the input-side rotating plates; and
a centrifugal clutch mechanism including weights movable from radially inward positions to radially outward positions by a centrifugal force caused by the rotation of the clutch housing;
the centrifugal clutch mechanism puts the input-side rotating plates and the output-side rotating plates into pressure contact with each other to provide a state where the transfer of the rotation driving force of the input shaft to the output shaft is allowed when the weights are at the radially outward positions;
the centrifugal clutch mechanism is configured to release the input-side rotating plates and the output-side rotating plates from a contact pressure force to provide a state where the transfer of the rotation driving force of the input shaft to the output shaft is blocked when the weights are at the radially inward positions;
the centrifugal clutch mechanism includes:
a contact structure contacted by the weights between the radially inward positions and the radially outward positions;
an elastic structure urging the weights in a radially inward direction;
a pressure-contact structure movable in an axial direction of the output shaft, by the movement of the weights from the radially inward positions to the radially output positions, to put the input-side rotating plates and the output-side rotating plates into pressure contact with each other; and
an urging structure urging the weight toward the contact structure in the axial direction of the output shaft and permitting the weight to move in the radial direction.
